(19) United States
(12) Patent Application Publication
(10) Pub. No.: US 2014/0097766 A1
(43) Pub. Date: Apr. 10, 2014

(54) Load Control Device and Lighting Apparatus

(71) Applicant: Toshiba Lighting & Technology Corporation, Yokosuka-shi (JP)

(72) Inventors: Koji Migita, Yokosuka-shi (JP); Akinori Imahashi, Yokosuka-shi (JP); Hiromi Matsumoto, Yokosuka-shi (JP); Takeo Yamaguchi, Yokosuka-shi (JP)

(73) Assignee: TOSHIBA LIGHTING & TECHNOLOGY CORPORATION, Yokosuka-shi (JP)

(21) Appl. No.: 14/014,507

(22) Filed: Aug. 30, 2013

(30) Foreign Application Priority Data
Oct. 9, 2012 (JP) 2012-223773
Dec. 17, 2012 (JP) 2012-274442
Dec. 28, 2012 (JP) 2012-286477

(51) Int. Cl. H05B 33/08

(52) U.S. Cl. CPC H05B 33/0839
USPC 315/256; 307/11

(57) ABSTRACT

A load control device includes saturable devices, loads, a phase controller, a bypass unit, and a controller. Plural saturable devices are connected in series to each other. Plural loads are respectively connected to the saturable devices and are supplied with power via the saturable devices. The phase controller phase-controls an output voltage of an AC power supply so as to be supplied to the respective loads. The bypass unit can supply a reduced bypass current so as to bypass the phase controller from a zero cross point of each half cycle of an AC power supply voltage. The controller sets an output of the phase controller and controls the output thereof to a set output value, and stops the supply of the bypass current in a condition in which a firing angle (conduction phase) is equal to or more than the predetermined value.

### CROSS-REFERENCE TO RELATED APPLICATIONS

This application is based upon and claims the benefit of priority from the prior Japanese Patent Applications No. 2012-223773 filed on October 9, No. 2012-274442 filed on December 17 and No. 2012-286477 filed on December 28, the entire contents of which are incorporated herein by reference.

### FIELD

Embodiments described herein relate generally to a load control device and a lighting apparatus which control a current flowing through a load to a constant current.

### BACKGROUND

In an airfield, a plurality of marker lamps are provided along a runway, a taxiway, and the like, for example, in order to guide taking off and landing from and to a runway, to guide an airplane to a runway, or to guide a landed airplane to a terminal. Lamps (lights) of the marker lamps are connected in series, and are turned on by being supplied with a constant current corresponding to a targeted luminous intensity level. In other words, the lamps are respectively connected to secondary sides of a plurality of saturable current transformers which are connected in series to a secondary side of an output transformer of a constant current power supply device. In addition, a phase control voltage of a phase controller which controls a phase of an AC voltage according to a luminous intensity control signal is input to a primary side of the output transformer. Further, feedback control is performed on the phase controller depending on an output current value. The phase control voltage is boosted by the output transformer as necessary such that a constant current corresponding to the luminous intensity control signal flows through the lamps via the saturable current transformers connected in series.

If, among the saturable current transformers connected in series, for example, a lamp of one saturable current transformer is burnt out, a high voltage occurs on the secondary side of the saturable current transformer when the saturable current transformer is saturated in a case where a triac of the phase controller is fired (conducted) or after the triac is fired, and thus the saturable current transformer may cause a problem such as dielectric breakdown.

A load control device is proposed in which a bypass current is made to flow for each half cycle of an AC current.

### BRIEF DESCRIPTION OF THE DRAWINGS

FIG. 1 is a schematic circuit diagram of a load control device according to a first embodiment.

FIGS. 2A to 2D are diagrams illustrating currents which are output by a phase controller and a bypass unit.

FIG. 3 is a schematic circuit diagram of a load control device according to a second embodiment.

FIG. 4 is a schematic circuit diagram of a load control device according to a third embodiment.

FIG. 5 is a schematic circuit diagram of a load control device according to a fourth embodiment.

FIGS. 6A to 6D are diagrams illustrating currents which are output by a phase controller and a bypass unit.

FIGS. 7A and 7B are diagrams illustrating low level currents which are output by a phase controller and a bypass unit.

FIG. 8 is a schematic circuit diagram of a load control device according to a fifth embodiment.

FIG. 9 is a schematic circuit diagram of a distortion detection circuit.

FIGS. 10A to 10C are diagrams illustrating a distortion voltage waveform and a reference voltage waveform when a bypass current is supplied.

FIGS. 11A to 11C are diagrams illustrating a distortion voltage waveform and a reference voltage waveform when a bypass current is not supplied.

FIG. 12 is a schematic circuit diagram of a load control device according to a sixth embodiment.

FIGS. 13A to 13D are diagrams illustrating currents which are output by a phase controller and a bypass unit.

FIGS. 14A and 14B are diagrams illustrating low level currents which are output by a phase controller and a bypass unit.

FIGS. 15A to 15E are diagrams illustrating a variation in a phase-controlled current according to a decrease in a firing angle.

FIGS. 16A to 16E are diagrams illustrating a variation in a phase-controlled current according to an increase in a firing angle.

FIG. 17 is a flowchart illustrating control performed by a controller.

FIG. 18 is a schematic circuit diagram of a load control device according to a seventh embodiment.

FIG. 19 is a schematic circuit diagram of a load control device according to an eighth embodiment.

### DETAILED DESCRIPTION

An object of the present embodiments is to provide a load control device and a lighting apparatus which can prevent the occurrence of high voltage due to burn-out of a load, and can perform constant current control corresponding to a luminous intensity control signal even in a case where an output side of a constant current power supply device is short-circuited or the number of loads is reduced.

In addition, another object of the present embodiments is to provide a load control device which can suppress overcurrent so as to perform constant current control corresponding to a luminous intensity control signal even in a case where an output side of a constant current power supply device is short-circuited or the number of loads is reduced.

A load control device of an exemplary embodiment includes saturable devices, loads, a phase controller, a bypass unit, and a controller.

A plurality of saturable devices are connected in series to each other. A plurality of loads are respectively connected to the saturable devices and are supplied with power via the saturable devices.

The phase controller phase-controls an output voltage of an AC power supply so as to be supplied to the respective loads. The bypass unit can supply a reduced bypass current so as to bypass the phase controller from a zero cross point of each half cycle of an AC power supply voltage.

The controller sets an output of the phase controller and controls the output thereof to a set output value, and stops the supply of the bypass current in a condition in which an output value is equal to or lower than a predetermined value, that is, a condition in which a firing angle (conduction phase) is equal to or more than the predetermined value.

According to the present exemplary embodiment, since a bypass current which bypasses the phase controller flows from a zero cross point of each half cycle of an AC power supply voltage, a current flows through the saturable device before the phase controller is fired (conducted). Therefore, a high voltage can be prevented from occurring or relaxed in the saturable device at a time point when the phase controller starts phase control even if the load is burnt out. In addition, since the controller stops the supply of a bypass current in a condition in which an output value of the phase controller is equal to or lower than a predetermined value, an output thereof is formed only by an output of the phase controller. Therefore, constant current control corresponding to a luminous intensity control signal can be performed even in a case where an output side is short-circuited or the number of loads is reduced.

Hereinafter, exemplary embodiments will be described with reference to the drawings.

First, first to fifth embodiments will be described.

The first embodiment will now be described.

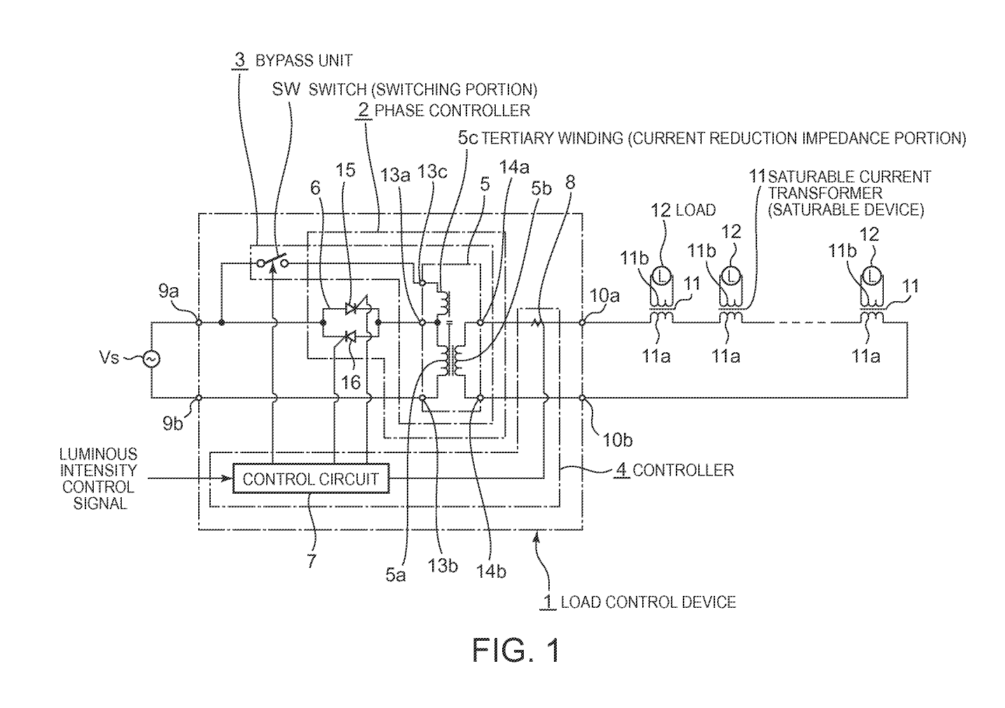

A load control device 1 according to the present embodiment performs constant current control on lights provided in a taxiway or the like of an airfield, and, as shown in FIG. 1, includes a phase controller 2, a bypass unit 3, and a controller 4. In addition, the phase controller 2 includes a leakage transformer 5 and a phase control circuit 6, and the bypass unit 3 includes a switch SW which is a switching portion and the leakage transformer 5. Further, the controller 4 includes a control circuit 7 and a current transformer 8.

The load control device 1 has input terminals 9a and 9b connected to an AC power supply Vs and output terminals 10a and 10b connected to saturable current transformers 11 which are a plurality of saturable devices connected in series. A load 12, which is a marker lamp using, for example, a light emitting diode as a light source, is connected to each of the saturable current transformers 11 so as to be supplied with power. A sinusoidal AC voltage (AC current) output from the AC power supply Vs is input to the input terminals 9a and 9b of the load control device 1.

In the leakage transformer 5 of the phase controller 2, both ends of a primary winding 5a which is a primary side are connected to input terminals 13a and 13b, both ends of a secondary winding 5b which is a secondary side are connected to output terminals 14a and 14b, and both ends of a tertiary winding 5c are connected to input terminals 13a and 13c. The input terminal 13b is connected to the input terminal 9b of the load control device 1, the input terminal 13a is connected to the input terminal 9a of the load control device 1 via the phase control circuit 6, and the input terminal 13c is connected to the input terminal 9a of the load control device 1 via the switch SW.

In other words, the input terminals 13a and 13b of the leakage transformer 5 are connected to the AC power supply Vs via the phase control circuit 6, and the input terminals 13c and 13b are connected to the AC power supply Vs via the switch SW. The leakage transformer 5 boosts an AC voltage input to the input terminals 13a (13c) and 13b so as to be output from the output terminals 14a and 14b.

Primary windings 11a of the saturable current transformers 11 are connected in series to the output terminals 14a and 14b. An AC current corresponding to an AC voltage which is input to the input terminals 13a (13c) and 13b flows through the primary winding 11a of the saturable current transformer 11.

The phase control circuit 6 includes thyristors 15 and 16 which are connected in parallel to each other in opposite directions, and is connected between the input terminal 9a and the input terminal 13a of the leakage transformer 5. The thyristors 15 and 16 control a phase of an AC voltage from the AC power supply Vs, and conduct the AC voltage from a time point when a gate signal (for example, a pulse signal) from the control circuit 7 is input to gates thereof to a time point when the AC voltage crosses the zero point (until the voltage becomes a self-holding current or less). During the conduction period, a phase-controlled voltage of the AC voltage is input between the input terminals 13a and 13b of the leakage transformer 5.

As above, the phase controller 2 controls a phase of an output voltage (a sinusoidal AC voltage) of the AC power supply Vs so as to be supplied to a plurality of loads 12.

The switch SW of the bypass unit 3 is connected between the input terminal 9a and the input terminal 13c of the leakage transformer 5. In other words, the switch SW is connected in parallel to the phase control circuit 6 via the tertiary winding 5c of the leakage transformer 5. Here, the tertiary winding 5c of the leakage transformer 5 is a current reduction impedance portion. The bypass unit 3 is formed so as to include the switch SW and the tertiary winding 5c of the leakage transformer 5 connected in series.

During a period when the phase controller 2 is not conducted, a sinusoidal voltage from the AC power supply Vs is input to the input terminals 13a and 13b of the leakage transformer 5 via the tertiary winding 5c. Thus, a reduced bypass current flows through the tertiary winding 5c and the primary winding 5a. The switch SW is controlled so as to be turned on and off by the control circuit 7 of the controller 4, and conducts an AC voltage during a turned-on period. In the present embodiment, the switch SW is normally controlled so as to be turned on by the control circuit 7. The switch SW may use a relay or a semiconductor switch. In this way, the bypass unit 3 can supply the reduced bypass current so as to bypass the phase controller 2 from a zero cross point of each half cycle of an AC voltage from the AC power supply Vs.

Each of the loads 12 is connected between both ends of a secondary winding 11b which is a secondary side of the saturable current transformer 11. The load 12 is a marker lamp which includes, for example, a light bulb or a light emitting diode and a turning-on control device of the light emitting diode. When a current output from the leakage transformer 5 flows through the primary winding 11a of the saturable current transformer 11, a current flows through the secondary winding 11b so as to turn on the load 12. The load 12 varies a luminous intensity level according to an output current from the leakage transformer 5. In this way, a plurality of loads 12 are supplied with power via a plurality of saturable current transformers 11 connected in series to each other so as to be turned on.

In addition, if the load 12 is a light bulb, both ends of the secondary winding 11b of the saturable current transformer 11 are opened when the light bulb is burnt out. In addition, if the load 12 is a light emitting diode, both ends of the secondary winding 11b of the saturable current transformer 11 are opened by a breaker such as a relay or a semiconductor switch provided between the secondary winding 11b of the saturable current transformer 11 and the turning-on control device when the light emitting diode is disconnected from the turning-on control device, or an abnormal state such as a failure of the turning-on control device occurs.

In the controller 4, the current transformer 8 is provided so as to detect a current which flows through the secondary winding 5b which is a secondary side of the leakage transformer 5. In other words, an output current of the leakage transformer 5 which flows through the saturable current transformer 11 is detected. A detected value of the output current of the leakage transformer 5 is input to the control circuit 7 at all times.

The control circuit 7 has a microcomputer, outputs a gate signal (for example, a pulse signal) to the thyristors 15 and 16 of the phase control circuit 6 so as to control an input period in the half cycle of an AC voltage which is input to the input terminals 13a and 13b of the leakage transformer 5, and performs control such that an output current of the leakage transformer 5 becomes a constant current corresponding to a luminous intensity level of the load 12.

The control circuit 7 receives a signal for setting an output of the phase controller 2, that is, a luminous intensity control signal for setting a luminous intensity level of the load 12, from an external device. A luminous intensity control signal in an airfield is typically set to five levels. In other words, a luminous intensity of the load 12 is varied to 100%, 25%, 5%, 1%, and 0.2%. However, the present embodiment is not limited thereto. For example, a signal for continuously varying a luminous intensity may be used.

In addition, the control circuit 7 receives a detected value of an output current of the leakage transformer 5 from the current transformer 8. Further, although not shown, the control circuit 7 is connected to the input terminals 9a and 9b and receives an AC current of the AC power supply Vs. The control circuit 7 detects zero cross timing of an AC voltage of the AC power supply Vs.

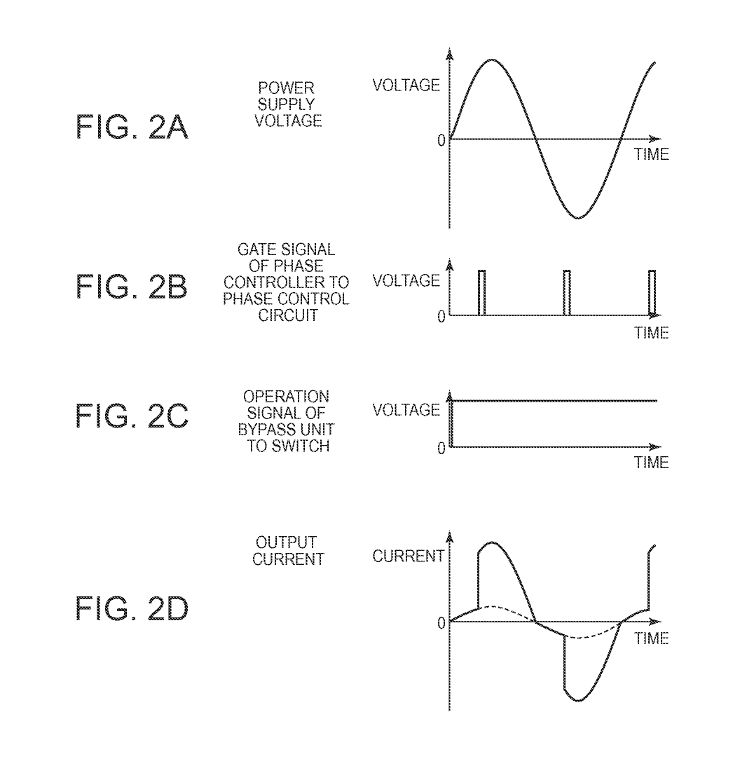

In addition, when the luminous intensity control signal is a control signal for turning on the load 12 in a certain luminous intensity level, the control circuit 7 calculates and determines a conduction period (conduction phase) of an AC voltage corresponding to the luminous intensity control signal, and outputs a gate signal as shown in FIG. 2B to the gates of the thyristors 15 and 16 of the phase control circuit 6 such that the AC voltage is input to the input terminals 13a and 13b of the leakage transformer 5 during the conduction period (conduction phase).

Therefore, an AC voltage of which a conduction period is controlled, that is, a phase-controlled voltage is input to the input terminals 13a and 13b of the leakage transformer 5. As a result, a voltage of a sum of a voltage by the bypass unit 3 and the phase-controlled voltage is input to the leakage transformer 5. The leakage transformer 5 boosts this voltage so as to be output from the output terminals 14a and 14b. A current as shown in FIG. 2D flows through the load 12 according to this output voltage so as to turn on the load 12.

In addition, as shown in FIG. 2C, if the luminous intensity control signal is a control signal for turning on the load 12 in a certain luminous intensity level, the control circuit 7 turns on the switch SW. A low AC voltage is input between the input terminals 13a and 13b of the leakage transformer 5 via the tertiary winding 5c, and thus a reduced bypass current flows therethrough. Accordingly, a low AC current flows between the output terminals 14a and 14b via the saturable current transformers 11.

Since a value of the AC voltage input to the input terminals 13a and 13b of the leakage transformer 5 is large after the phase control circuit 6 is controlled so as to be conducted, an output current from the leakage transformer 5 is a low current until the phase control circuit 6 is controlled so as to be conducted, as shown in FIG. 2D, and is a current (large current) of which a phase is controlled by the phase control circuit 6 from a time point when the phase control circuit 6 is controlled so as to be conducted to a zero cross point of an AC current.

Further, the control circuit 7 controls a conduction period (conduction phase) of the thyristors 15 and 16 of the phase control circuit 6 such that a current detected by the current transformer 8 becomes a predetermined current corresponding to a luminous intensity control signal. In other words, the controller 4 sets an output of the phase controller 2 and uniformly controls, namely, controls and maintains the output thereof to a set output value according to an input luminous intensity control signal. Accordingly, the load 12 is turned on in a luminous intensity level corresponding to the luminous intensity control signal.

In addition, the control circuit 7 turns off the switch SW when a conduction period of the phase control circuit 6 is equal to or lower than a predetermined value, that is, a firing angle (conduction phase) of the phase control circuit 6 is equal to or more than the predetermined value. In other words, the controller 4 stops the supply of a bypass current using the bypass unit 3 in a condition in which an output value of the phase controller 2 is equal to or lower than a predetermined value. The predetermined value of a conduction period in the present embodiment is set in advance, and is set to, for example, 160° or 170° in the half cycle 0 to 180° of an AC voltage. If the switch SW is turned off, an output current of the leakage transformer 5 is varied only by control of the phase control circuit 6.

In addition, the conduction period and the conduction phase indicate conduction of the phase controller 2, the phase control circuit 6, and the like, and indicate the substantially same thing as each other.

Further, the phase control circuit 6 is not limited to a configuration using the thyristors 15 and 16, and may be a configuration of phase-controlling an AC voltage of the AC power supply Vs such as a switching unit or a triac using a diode bridge and a transistor.

Next, an operation of the first embodiment will be described.

When a luminous intensity control signal is a control signal for turning on the load 12 in a certain luminous intensity level, the switch SW is turned on by the control circuit 7, and thus a low output current flows between the output terminals 14a and 14b of the leakage transformer 5 at all times. In other words, a low current flows through the saturable current transformers 11 even in a period when the thyristors 15 and 16 of the phase control circuit 6 are not conducted. Therefore, when the load 12 is burnt out, a pulsive high voltage does not occur between both ends of the secondary winding 11b of the saturable current transformer 11 at a time point when the thyristors 15 and 16 of the phase control circuit 6 are conducted.

In addition, there are cases where both ends of the secondary winding 5b of the leakage transformer 5 are short-circuited, or the number of the loads 12 is reduced, due to a test, construction, maintenance, or the like. Further, there are cases where the load 12 is turned on in a low luminous intensity level. In these cases, the control circuit 7 of the controller 4 controls a conduction period of the phase control circuit 6 such that an output current of the phase controller 2 becomes a current corresponding to a luminous intensity control signal through uniform control. Specifically, a conduction phase of the thyristors 15 and 16 is feedback-controlled depending on a detection signal of the current transformer 8. Therefore, conduction of the thyristors 15 and 16 is intended to be delayed so as to reduce an output current in a case of a light load as described above. In addition, when the conduction period becomes a predetermined value set in advance, the control circuit 7 turns off the switch SW. As above, the control circuit 7 turns off the switch SW and controls the thyristors 15 and 16 of the phase control circuit 6 such that a predetermined current corresponding to a luminous intensity control signal flows between the output terminals 14a and 14b of the leakage transformer 5. Accordingly, control can be performed such that the predetermined current corresponding to the luminous intensity control signal flows through the saturable current transformers 11.

According to the load control device 1 of the present embodiment, when a luminous intensity control signal is a control signal for turning on the load 12 in a certain luminous intensity level, the control circuit 7 controls the switch SW so as to be turned on. Thus, a current flows from the output terminals 14a and 14b of the leakage transformer 5 to the saturable current transformers 11 before the phase control circuit 6 is conducted, and therefore there is an effect that a high voltage can be prevented from occurring in the saturable current transformer 11 at a time point when the phase control circuit 6 is conducted even if the load 12 is burnt out.

In addition, since the control circuit 7 controls the switch SW so as to be turned off when a conduction period of the phase control circuit 6 is equal to or lower than a predetermined value, that is, the control circuit 7 controls the switch SW so as to be turned off when a firing angle (conduction phase) of the phase control circuit 6 is equal to or more than the predetermined value, an output of the phase controller 2 (the leakage transformer 5) is formed only by an output controlled by the phase control circuit 6. Therefore, even in a case where the output side of the leakage transformer 5 is short-circuited or the number of loads 12 is reduced, overcurrent can be prevented from occurring in the primary side of the leakage transformer 5 or the load 12 side and to thereby perform constant current control corresponding to a luminous intensity control signal.

Further, the bypass unit 3 is formed so as to include the switch SW which is a switching portion and the tertiary winding 5c of the leakage transformer 5 which is a current reduction impedance portion, connected in series, and can supply a reduced bypass current so as to bypass the phase controller 2 when conduction of the switch SW is controlled by the controller 4. Therefore, there is an effect that a high voltage can be prevented from occurring in the saturable current transformer 11 and to form the load control device 1 at low cost with a simple configuration.

Next, the second embodiment will be described.

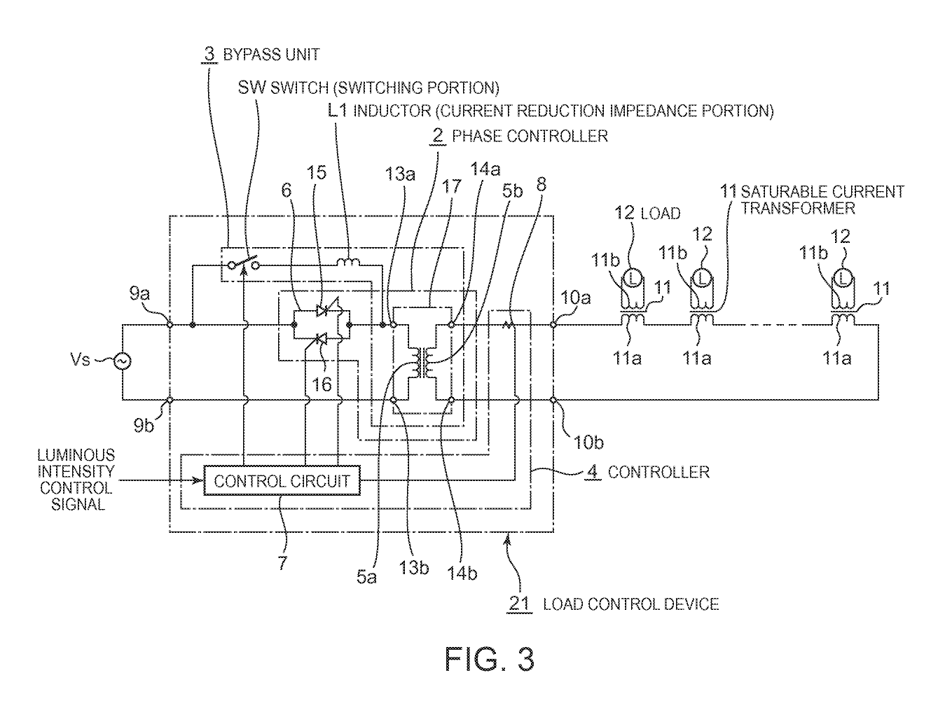

Next, a load control device 21 of the second embodiment will be described. The load control device 21 is configured as shown in FIG. 3.

The load control device 21 has a configuration in which the leakage transformer 5 of the load control device 1 shown in FIG. 1 is replaced with a transformer 17 and an inductor L1 which is a current reduction impedance portion, and has the same operations and effects as the load control device 1.

In addition, the load control devices 1 and 21 of the first and second embodiments include not only the phase controller 2, the bypass unit 3, and the controller 4, but also the saturable current transformers 11 which are a plurality of saturable devices and a plurality of loads 12.

Further, a saturable device of the first and second embodiments is not limited to the saturable current transformer 11, and may use a saturable transformer, a saturable reactor, or a device formed by a semiconductor switch which conducts a predetermined voltage.

Next, the third embodiment will be described.

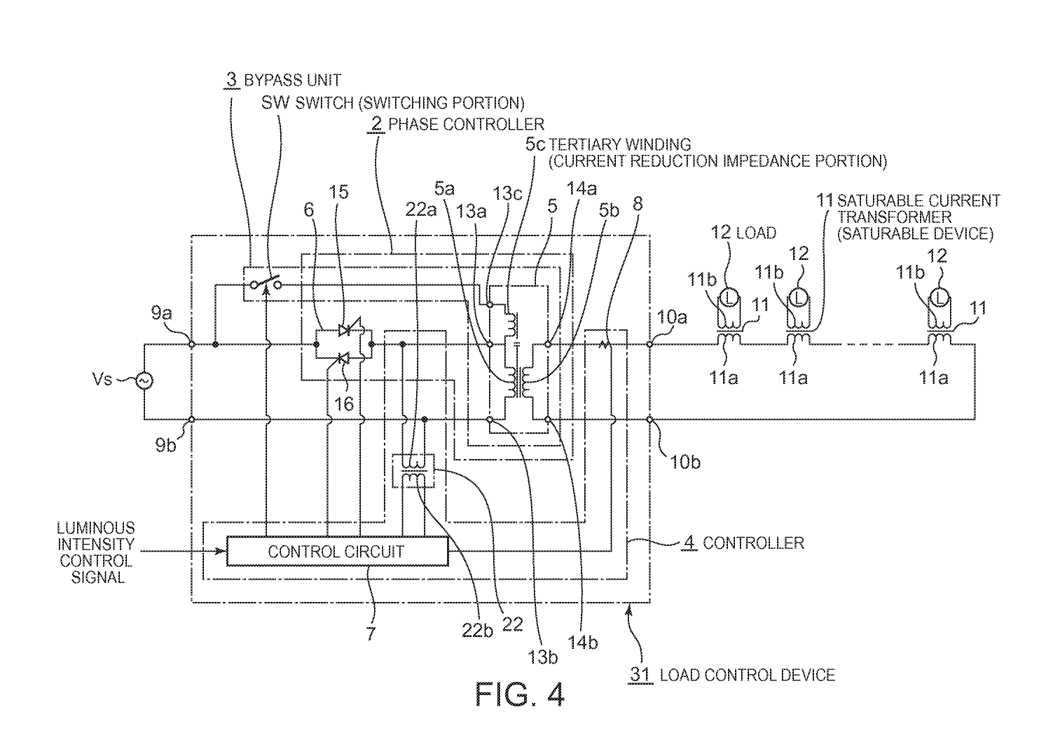

A load control device 31 of the present embodiment is configured as shown in FIG. 4. In addition, in FIG. 4, the same part as in FIG. 1 is given the same reference numeral, and description thereof will be omitted.

The load control device 31 has a configuration in which a transformer 22 which is a voltage detector is provided in the controller 4 in the load control device 1 shown in FIG. 1. Both ends of a primary winding 22a of the transformer 22 are connected to the input terminals 13a and 13b of the leakage transformer 5, and both ends of a secondary winding 22b are connected to the control circuit 7. The transformer 22 detects an output voltage of the phase control circuit 6, and inputs the detected voltage to the control circuit 7.

A value of the detected voltage is an effective value, a peak (maximum) value, or the like. In addition, in the present embodiment, a voltage between the input terminals 13a and 13b of the leakage transformer 5, that is, a voltage obtained by also adding a voltage using the bypass unit 3 is detected, but a voltage correlated with an output voltage of the phase control circuit 6 can be detected, and thus there is no problem. In addition, a voltage detector is not limited to the transformer 22 of FIG. 4.

The control circuit 7 controls the switch SW so as to be turned off when a voltage detected by the transformer 22 is equal to or lower than a predetermined value. The predetermined value is set in advance. In other words, the controller 4 stops the supply of a bypass current using the bypass unit 3 when a detected voltage of the transformer 22 is equal to or lower than a predetermined value.

If the switch SW is turned off, an output current of the leakage transformer 5 is varied only by control of the phase control circuit 6. Therefore, a predetermined current corresponding to a luminous intensity control signal flows through the saturable current transformers 11, and thus the loads 12 are turned on.

According to the load control device 31 of the present embodiment, since the control circuit 7 controls the switch SW so as to be turned off when a voltage detected by the transformer 22 which is a voltage detector is equal to or lower than a predetermined value, an output of the phase controller 2 (the leakage transformer 5) is formed only by an output controlled by the phase control circuit 6. Therefore, there is an effect that, even in a case where the output side of the leakage transformer 5 is short-circuited or the number of loads is reduced, overcurrent can be prevented from occurring in the primary side or the secondary side of the leakage transformer 5, thereby performing constant current control corresponding to a luminous intensity control signal.

In addition, in the present embodiment, the leakage transformer 5 may be omitted, and the phase controller 2 may be directly connected to the saturable current transformers 11 which are connected in series. In this case, a current limiting impedance portion may be connected to the line path in preparation for short-circuit of the load 12 side.

Next, the fourth embodiment will be described.

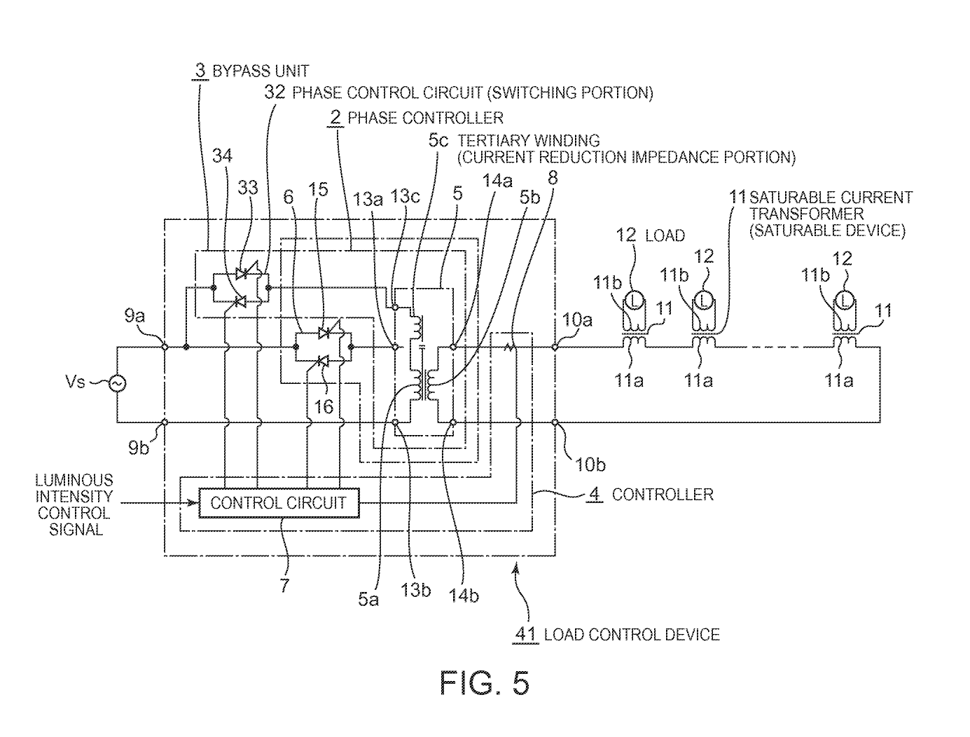

A load control device 41 of the present embodiment is configured as shown in FIG. 5. In addition, in FIG. 5, the same part as in FIG. 1 is given the same reference numeral, and description thereof will be omitted.

The load control device 41 has a configuration in which the switch SW of the bypass unit 3 is replaced with a phase control circuit 32 which is a switching portion in the load control device 1 shown in FIG. 1. The phase control circuit 32 includes thyristors 33 and 34 which are connected in parallel to each other in opposite directions, and is connected between the input terminal 9a of the load control device 41 and the input terminal 13c of the leakage transformer 5. The thyristors 33 and 34 alternately conduct an AC voltage from the AC power supply Vs, and conduct the AC voltage from a time point when a gate signal (pulse signal) is input to gates thereof from the control circuit 7. Through the conduction, the AC voltage is input between the input terminals 13a and 13b of the leakage transformer 5.

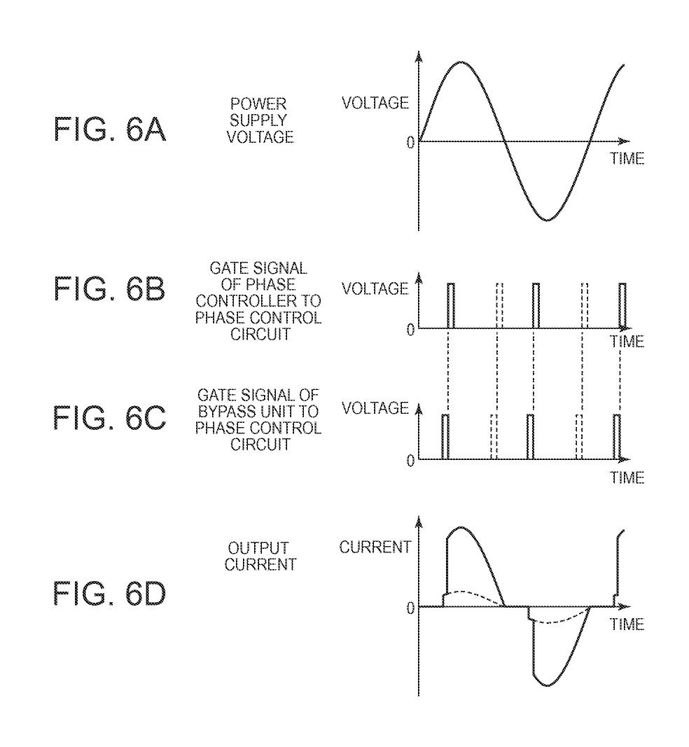

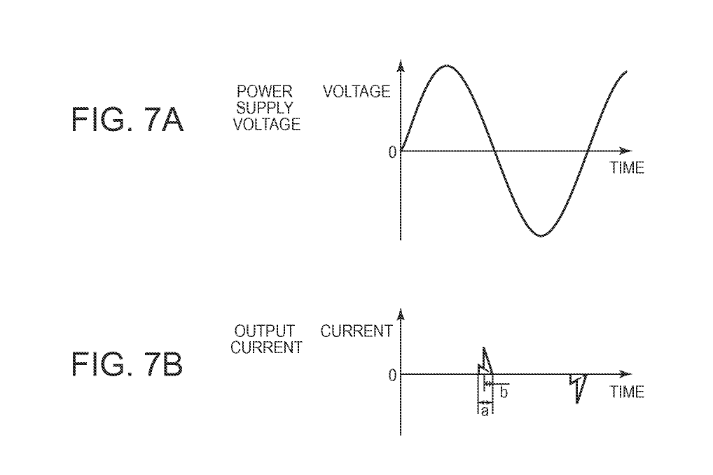

Further, as shown in FIGS. 6B and 6C, the control circuit 7 outputs a gate signal to the thyristors 33 and 34 of the phase control circuit 32 of the bypass unit 3 immediately before a gate signal is output to the thyristors 15 and 16 of the phase control circuit 6 of the phase controller 2. In other words, at least in a condition in which an output value of the phase controller 2 is equal to or lower than a predetermined value, the controller 4 starts the supply of a bypass current using the bypass unit 3 immediately before the phase control circuit 6 of the phase controller 2 is conducted. In addition, the gate signal indicated by the broken line in FIGS. 6B and 6C is used to generate an output of FIG. 7B.

As shown in FIG. 7B, the control circuit 7 controls the thyristors 15 and 16 of the phase control circuit 6 and the thyristors 33 and 34 of the phase control circuit 32, respectively, for example, such that the conduction period (conduction phase) b when the phase control circuit 6 of the phase controller 2 is conducted is equal to or lower than the conduction period (conduction phase) a when the phase control circuit 32 of the bypass unit 3 is conducted.

In a condition in which an output value of the phase controller 2 exceeds a predetermined value, as shown in FIG. 6D, an output current of the phase controller 2 becomes a large current corresponding to a luminous intensity control signal. In addition, in a condition in which an output value of the phase controller 2 is equal to or lower than the predetermined value, as shown in FIG. 7B, an output current of the phase controller 2 becomes a low level current. In either case, a low output current is allowed to flow by the bypass unit 3 immediately before an output current of the phase controller 2 flows. In other words, a low current flows immediately before an output current for turning on the load 12 flows from the output terminals 14a and 14b of the leakage transformer 5 to the saturable current transformer 11. Therefore, a high voltage is prevented from occurring in the saturable current transformer 11 at a time point when the thyristors 15 and 16 of the phase control circuit 6 are conducted.

According to the load control device 41 of the present embodiment, since the control circuit 7 controls the phase control circuit 32 of the bypass unit 3 so as to be conducted immediately before the phase control circuit 6 of the phase controller 2 is conducted, a current flows from the output terminals 14a and 14b of the leakage transformer 5 to the saturable current transformer 11 before the phase control circuit 6 is conducted. Therefore, there is an effect that a high voltage is prevented from occurring in the saturable current transformer 11 at a time point when the phase control circuit 6 is conducted even if the load 12 is burnt out.

In addition, in a condition in which an output value of the phase controller 2 is equal to or lower than a predetermined value, since a bypass current starts to be supplied by the bypass unit 3 immediately before the phase control circuit 6 is conducted, an output of the leakage transformer 5 is formed by an output controlled by the phase control circuit 6 and a slight bypass current. Therefore, there is an effect that, even in a case where the output side of the leakage transformer 5 is short-circuited or the number of loads 12 is reduced, overcurrent can be prevented from occurring in the primary side or the secondary side of the leakage transformer 5 and constant current control corresponding to a luminous intensity control signal ban be performed.

Further, in the present embodiment, in a case where an output value of the phase controller 2 exceeds a predetermined value, a bypass current may be allowed to flow from the zero cross point of an AC voltage.

Next, the fifth embodiment will be described.

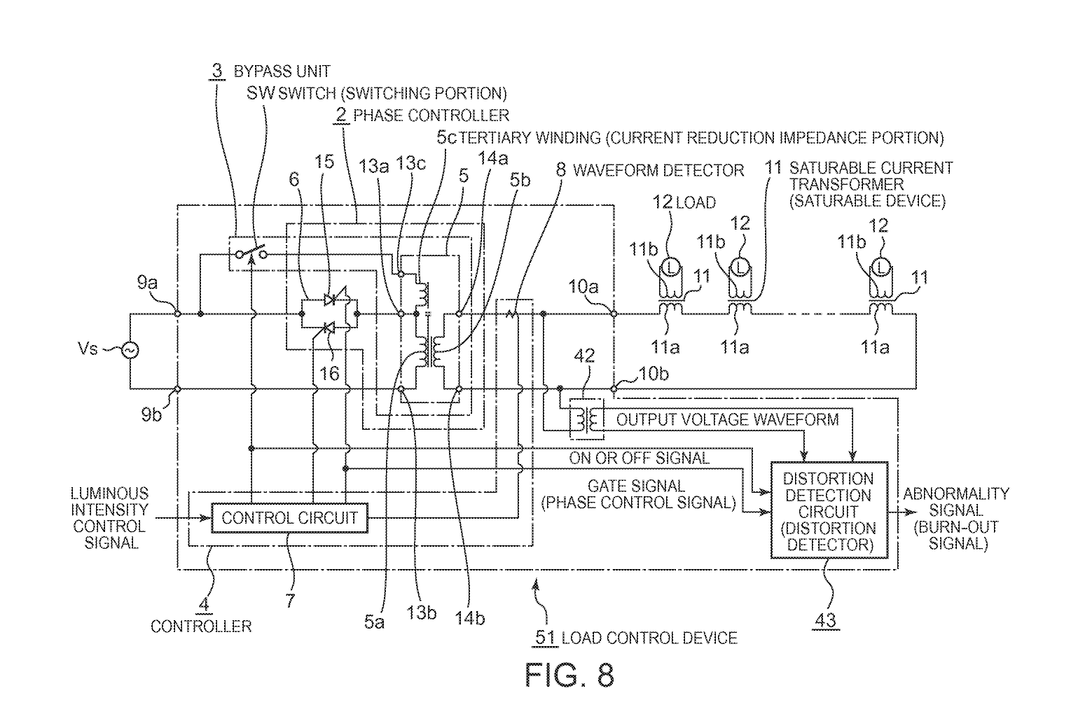

A load control device 51 of the present embodiment is configured as shown in FIG. 8. In addition, in FIG. 8, the same part as in FIG. 1 is given the same reference numeral, and description thereof will be omitted.

The load control device 51 has a configuration in which a transformer 42 which detects an output voltage waveform of the phase controller 2 and a distortion detection circuit 43 which is a distortion detector are provided in the load control device 1 shown in FIG. 1. The transformer 42 is connected between the output terminals 10a and 10b of the load control device 51 (between the output terminals 14a and 14b of the leakage transformer 5). An output voltage waveform detected by the transformer 42 is input to the distortion detection circuit 43. In addition, the transformer 42 is preferably provided between the output terminals 10a and 10b in terms of more accurately detecting an output voltage, but is preferably provided between the terminals 13a and 13b in terms of capable of using a transformer with a low voltage resistance specification.

The distortion detection circuit 43 detects a distortion component of the output voltage waveform so as to detect burn-out of the load 12. In addition, the distortion detection circuit 43 receives a control signal from the control circuit 7 of the controller 4 so as to detect a distortion component of an output voltage waveform in response to the control signal. In other words, an On or Off signal for controlling turning-on and turning-off of the switch SW of the bypass unit 3 and a gate signal for controlling conduction of the thyristor 15 of the phase control circuit 6 of the phase controller 2 are input to the distortion detection circuit 43.

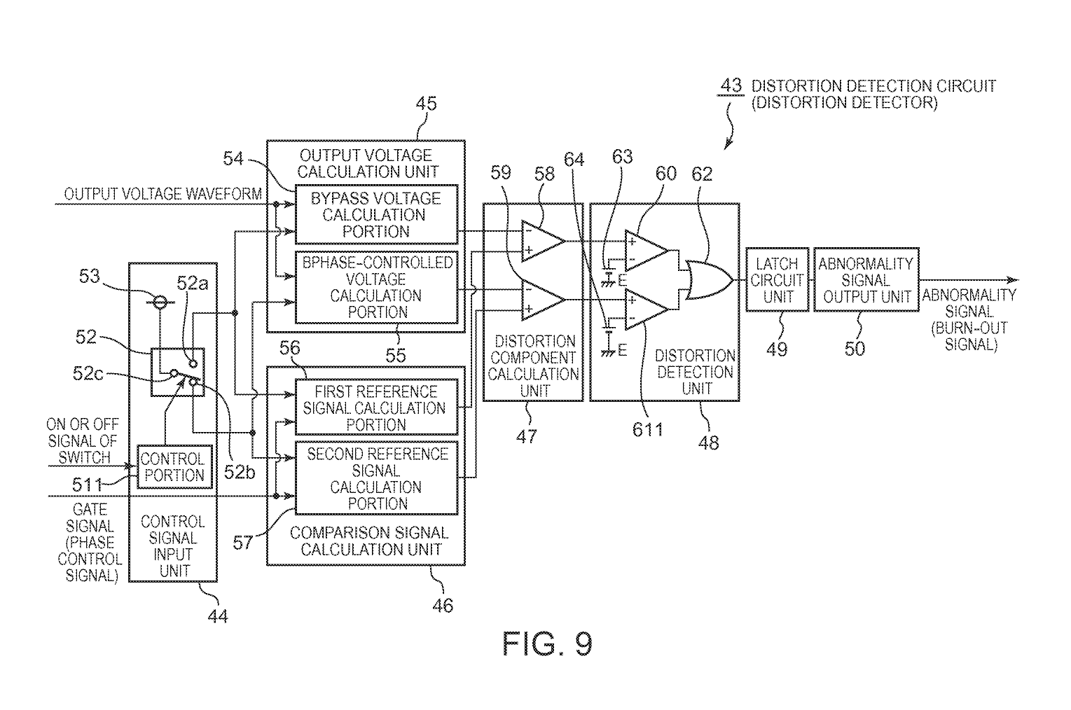

The distortion detection circuit 43 includes, as shown in FIG. 9, a control signal input unit 44, an output voltage calculation unit 45, a comparison signal calculation unit 46, a distortion component calculation unit 47, a distortion detection unit 48, and a latch circuit unit 49, and an abnormality signal output unit 50.

The control signal input unit 44 allows the On or Off signal of the switch SW output from the control circuit 7 and the gate signal of the thyristor 15 to be input thereto, so as to operate the output voltage calculation unit 45 and the comparison signal calculation unit 46 in response to these control signals. The control signal input unit 44 includes a control portion 511, a changing switch 52, and a constant current source 53.

The constant current source 53 is connected to a common contact 52c of the changing switch 52, and outputs a constant voltage, for example, DC 5V to the common contact 52c. A normally open contact 52a of the changing switch 52 is connected to a bypass voltage calculation portion 54 of the output voltage calculation unit 45 and a first reference signal calculation portion 56 of the comparison signal calculation unit 46. In addition, a normally closed contact 52b of the changing switch 52 is connected to a phase-controlled voltage calculation portion 55 of the output voltage calculation unit 45 and a second reference signal calculation portion 57 of the comparison signal calculation unit 46.

The On or Off signal of the switch SW is input to the control portion 511. If the On or Off signal is an On signal for closing the switch SW, the control portion 511 connects the common contact 52c of the changing switch 52 to the normally open contact 52a. Accordingly, a constant voltage of the constant current source 53 is input to the bypass voltage calculation portion 54 of the output voltage calculation unit 45 and the first reference signal calculation portion 56 of the comparison signal calculation unit 46 as a control signal.

Further, If the On or Off signal is an Off signal for opening the switch SW, the control portion 511 connects the common contact 52c of the changing switch 52 to the normally closed contact 52b. Accordingly, a constant voltage of the constant current source 53 is input to the phase-controlled voltage calculation portion 55 of the output voltage calculation unit 45 and the second reference signal calculation portion 57 of the comparison signal calculation unit 46 as a control signal. In addition, the gate signal of the thyristor 15 is input to the first reference signal calculation portion 56 and the second reference signal calculation portion 57 of the comparison signal calculation unit 46.

The output voltage calculation unit 45 includes the bypass voltage calculation portion 54 and the phase-controlled voltage calculation portion 55, and an output voltage waveform detected by the transformer 42 is input to each of the bypass voltage calculation portion 54 and the phase-controlled voltage calculation portion 55.

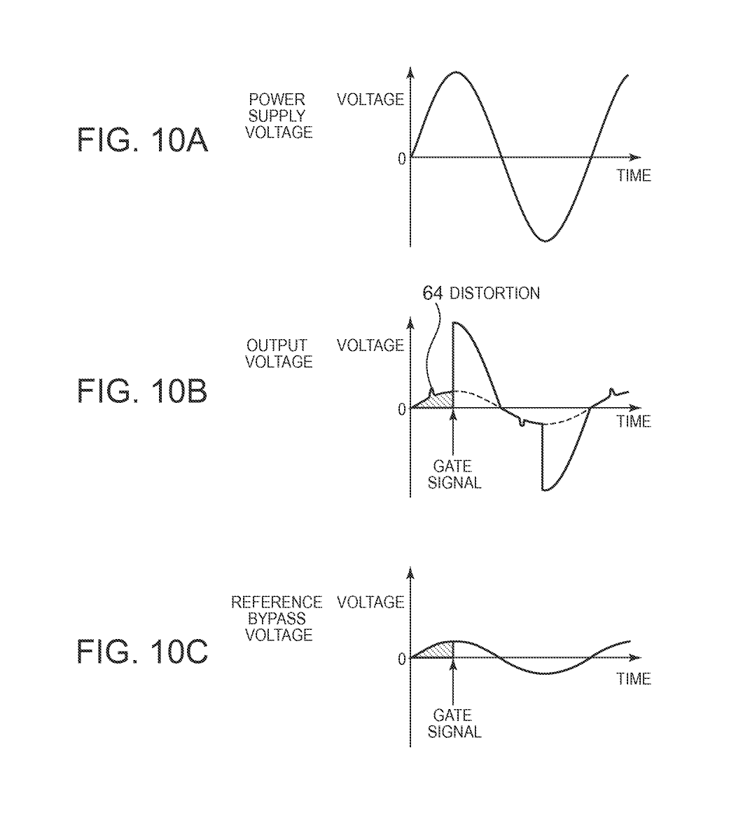

The bypass voltage calculation portion 54 calculates a voltage value (integrated value) of an output voltage of the phase controller 2 when a bypass current is supplied. In other words, as shown in FIG. 10B, a voltage value in a period from the zero cross point to the time when the thyristor 15 is conducted is calculated through integration of the output voltage waveform. The period from the zero cross point to the time when the thyristor 15 is conducted is a bypass current period. The bypass voltage calculation portion 54 is operated when a constant voltage (for example, DC 5V) of the constant current source 53 is input thereto from the control signal input unit 44, and calculates the voltage value.

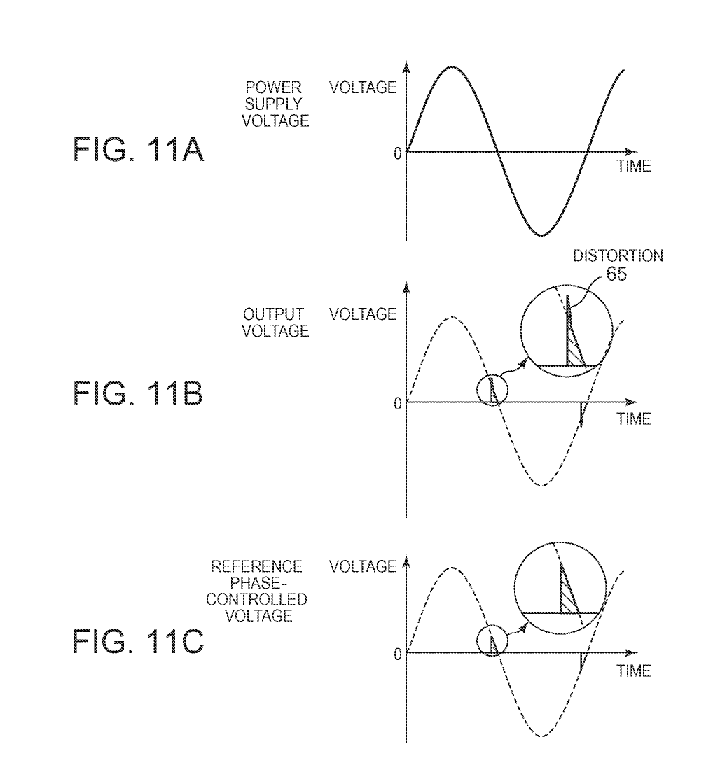

In addition, the phase-controlled voltage calculation portion 55 calculates a voltage value (integrated value) of an output voltage of the phase controller 2 in a conduction period of the thyristor 15. In other words, as shown in FIG. 11B, a voltage value in a period from a conduction start point of the thyristor 15 to a conduction end point thereof is calculated through integration of the output voltage waveform. The period from a conduction start point of the thyristor 15 to a conduction end point thereof is a conduction period of the phase controller 2. The phase-controlled voltage calculation portion 55 is operated when a constant voltage (for example, DC 5V) of the constant current source 53 is input thereto from the control signal input unit 44, and calculates the voltage value.

The comparison signal calculation unit 46 includes the first reference signal calculation portion 56 and the second reference signal calculation portion 57, and a gate signal is input to each of the first and second reference signal calculation portions 56 and 57 from the control circuit 7.

The first reference signal calculation portion 56 calculates a first reference signal which is compared with the voltage value calculated by the bypass voltage calculation portion 54, and stores a voltage waveform of an output voltage for a bypass current as a reference bypass voltage waveform. In other words, the reference bypass voltage waveform is a voltage waveform of an output voltage which is generated between both ends of the secondary winding 5b when a bypass current flows through the primary winding 5a of the leakage transformer 5.

In addition, as shown in FIG. 10C, the first reference signal calculation portion 56 integrates the reference bypass voltage waveform in a period from the zero cross point to the time when the gate signal is input so as to calculate the first reference signal. The period from the zero cross point to the time when the gate signal is input is also a bypass current period. The first reference signal calculation portion 56 is operated when a constant voltage (for example, DC 5V) of the constant current source 53 is input thereto from the control signal input unit 44, and calculates the first reference signal.

In addition, the second reference signal calculation portion 57 calculates a second reference signal which is compared with the voltage value calculated by the phase-controlled voltage calculation portion 55, and stores a voltage waveform of an output voltage for a a sinusoidal AC current of the AC power supply Vs as a reference phase-controlled voltage waveform. In other words, the reference phase-controlled voltage waveform is a voltage waveform of an output voltage which is generated between both ends of the secondary winding 5b when a sinusoidal AC current from the AC power supply Vs flows through the primary winding 5a of the leakage transformer 5.

Further, as shown in FIG. 11C, the second reference signal calculation portion 57 integrates the reference phase-controlled voltage waveform in a period from a time point when the gate signal is input to the zero cross point so as to calculate the second reference signal. The period from the time point when the gate signal is input to the zero cross point is also a conduction period of the phase controller 2. The second reference signal calculation portion 57 is operated when a constant voltage (for example, DC 5V) of the constant current source 53 is input thereto from the control signal input unit 44, and calculates the second reference signal.

In addition, in the output voltage calculation unit 45 and the comparison signal calculation unit 46, the output voltage waveform of the phase controller 2, the reference bypass voltage waveform, and the reference phase-controlled voltage waveform are synchronized with an AC voltage waveform of the AC power supply Vs. Therefore, the period from the zero cross point for the output voltage waveform to the time when the thyristor 15 is conducted, and the period from the zero cross point for the reference phase-controlled voltage waveform to the time when the gate signal is input, are periods from the zero cross point of an AC voltage of the AC power supply Vs to the time when a phase is controlled by the phase controller 2.

The distortion component calculation unit 47 includes a first difference calculation circuit 58 and a second difference calculation circuit 59. The voltage value of an output voltage for a bypass current calculated by the bypass voltage calculation portion 54 is input to an inverting input terminal of the first difference calculation circuit 58, and the first reference signal calculated by the first reference signal calculation portion 56 is input to a non-inverting input terminal thereof. In addition, the voltage value of an output voltage for a phase-controlled current calculated by the phase-controlled voltage calculation portion 55 is input to an inverting input terminal of the second difference calculation circuit 59, and the second reference signal calculated by the second reference signal calculation portion 57 is input to a non-inverting input terminal thereof.

The first difference calculation circuit 58 calculates a difference between the voltage value of an output voltage for a bypass current and the first reference signal so as to be amplified and be output. In other words, the first difference calculation circuit 58 outputs a distortion component of the output voltage for the bypass current. In addition, the second difference calculation circuit 59 calculates a difference between the voltage value of an output voltage for a phase-controlled current and the second reference signal so as to be amplified and be output. In other words, the second difference calculation circuit 59 outputs a distortion component of the output voltage for the phase-controlled current.

The respective distortion components output from the first and second difference calculation circuits 58 and 59 are input to the distortion detection unit 48. The distortion detection unit 48 includes a first comparator 60, a second comparator 611, and a logical sum circuit 62.

The distortion component of the output voltage for the bypass current output from the first difference calculation circuit 58 is input to a non-inverting input terminal of the first comparator 60, and a first reference value is input to an inverting input terminal thereof from a first reference voltage source 63. The first comparator 60 compares the distortion component with the first reference value, outputs a high level signal (for example, DC 5V) to the logical sum circuit 62 when the distortion component is equal to or more than the first reference value, and outputs a low level signal to the logical sum circuit 62 when the distortion component is smaller than the first reference value.

The distortion component of the output voltage for the phase-controlled current output from the second difference calculation circuit 59 is input to a non-inverting input terminal of the second comparator 611, and a second reference value is input to an inverting input terminal thereof from a second reference voltage source 64. The second comparator 611 compares the distortion component with the second reference value, outputs a high level signal (for example, DC 5V) to the logical sum circuit 62 when the distortion component is equal to or more than the second reference value, and outputs a low level signal to the logical sum circuit 62 when the distortion component is smaller than the second reference value.

The logical sum circuit 62 outputs a high level signal (for example, DC 5V) if a high level signal is input from at least one of the first comparator 60 and the second comparator 611. The high level signal is held in the latch circuit unit 49, and is input to the abnormality signal output unit 50. The abnormality signal output unit 50 outputs an abnormality signal (burn-out signal) in response to the high level signal.

As above, the distortion detection circuit 43 detects waveform distortion of an output voltage of the phase controller 2 caused by an abnormality (burn-out) of the load 12. In addition, the control circuit 7 operates the distortion detection circuit 43 during the bypass current period when a bypass current is supplied, and operates the distortion detection circuit 43 during the conduction period of the phase controller 2 when the bypass current stops being supplied.

Next, an operation of the fifth embodiment will be described.

As described in the first embodiment, the control circuit 7 of the controller 4 turns on the switch SW of the bypass unit 3 so as to supply a bypass current which bypasses the phase controller 2 when a luminous intensity control signal is a control signal for turning on the load 12 in a certain luminous intensity level, and turns off the switch SW so as to stop the supply of the bypass current in a condition in which an output value of the phase controller 2 is equal to or lower than a predetermined value.

In the distortion detection circuit 43, the control portion 511 of the control signal input unit 44 connects the common contact 52c of the changing switch 52 to the normally open contact 52a when the switch SW is turned on, so as to operate the bypass voltage calculation portion 54 of the output voltage calculation unit 45 and the first reference signal calculation portion 56 of the comparison signal calculation unit 46.

The bypass voltage calculation portion 54 integrates an output voltage waveform detected by the transformer 42 from the zero cross point thereof to the time when a phase-controlled voltage starts rising (to the time when a phase-controlled current starts being supplied) so as to calculate a voltage value of an output voltage for a bypass current, and the first reference signal calculation portion 56 integrates a prestored reference bypass voltage waveform from the zero cross point thereof to a time point when a gate signal is input (a bypass current period) so as to calculate a first reference signal.

The first difference calculation circuit 58 of the distortion component calculation unit 47 compares the voltage value of an output voltage for a bypass current calculated by the bypass voltage calculation portion 54 with the first reference signal calculated by the first reference signal calculation portion 56. Here, if the load 12 is not burnt out, the voltage value of an output voltage for a bypass current is substantially the same as the first reference signal, and thus a difference therebetween is approximately zero.

However, if the load 12 is burnt out, as shown in FIG. 10B, a distortion 64 occurs in the output voltage waveform for the bypass current. In other words, the primary winding 11a of the saturable device 11 which connects the burnt-out load 12 is saturated while the output voltage (output current) increases. This saturation varies impedance between the output terminals 10a and 10b of the load control device 41, and thus the distortion 64 occurs in the output voltage waveform. The distortion 64 increases as the number of burnt-out loads 12 becomes large. In addition, the distortion 64 occurs in the output voltage waveform for a bypass current before a phase-controlled current flows.

The first comparator 60 of the distortion detection unit 48 compares the difference (distortion component) between the voltage value of an output voltage for a bypass current and the first reference signal, calculated by the first difference calculation circuit 58, with the first reference value of the first reference voltage source 63. In addition, the first comparator 60 outputs a high level signal when the difference (distortion component) is equal to or more than the first reference value. Further, a high level signal is output from the logical sum circuit 62, and the abnormality signal output unit 50 outputs an abnormality signal (burn-out signal) in response to the high level signal. The burn-out of the load 12 can be recognized by receiving the abnormality signal.

In addition, when the switch SW is turned off and thus a bypass current stops being supplied, the control portion 511 of the control signal input unit 44 connects the common contact 52c of the changing switch 52 to the normally closed contact 52b, so as to operate the phase-controlled voltage calculation portion 55 of the output voltage calculation unit 45 and the second reference signal calculation portion 57 of the comparison signal calculation unit 46.

The phase-controlled voltage calculation portion 55 integrates an output voltage waveform detected by the transformer 42 from a rising start point to the zero cross point thereof (from a supply start point of a phase-controlled current to a supply end point thereof) so as to calculate a voltage value of the output voltage for the phase-controlled current, and the second reference signal calculation portion 57 integrates a prestored reference phase-controlled voltage waveform from a time point when a gate signal is input to the zero cross point (a conduction period of the phase controller 2) so as to calculate a second reference signal.

The second difference calculation circuit 59 of the distortion component calculation unit 47 compares the voltage value of an output voltage for a phase-controlled current calculated by the phase-controlled voltage calculation portion 55 with the second reference signal calculated by the second reference signal calculation portion 57. Here, if the load 12 is not burnt out, the voltage value of an output voltage for a phase-controlled current is substantially the same as the second reference signal, and thus a difference therebetween is approximately zero.

However, if the load 12 is burnt out, as shown in FIG. 11B, a distortion 65 occurs in the output voltage waveform for a phase-controlled current. In other words, the primary winding 11a of the saturable device 11 which connects the burnt-out load 12 is instantaneously saturated after the output voltage rises.

This saturation varies impedance between the output terminals 10a and 10b of the load control device 41, and thus the steep distortion 65 occurs in the output voltage waveform. The distortion 65 increases as the number of burnt-out loads 12 becomes large.

The second comparator 611 of the distortion detection unit 48 compares the distortion component which is a difference between the voltage value of an output voltage for a phase-controlled current and the second reference signal, calculated by the second difference calculation circuit 59, with the second reference value of the second reference voltage source 64. In addition, the second comparator 611 outputs a high level signal when the distortion component is equal to or more than the second reference value. Further, a high level signal is output from the logical sum circuit 62, and the abnormality signal output unit 50 outputs an abnormality signal (burn-out signal) in response to the high level signal. The burn-out of the load 12 can be recognized by receiving the abnormality signal.

As described above, when an On signal of the switch SW is output from the control circuit 7 and thus a bypass current is supplied, the distortion detection circuit 43 compares the distortion component of an output voltage waveform of the phase controller 2, generated between the output terminals 10a and 10b of the load control device 51 (between the output terminals 14a and 14b of the leakage transformer 5), with the first reference value in a bypass current period. In addition, when an Off signal of the switch SW is output from the control circuit 7 and thus a bypass current stops being supplied by the control signal, the distortion detection circuit 43 compares the distortion component of an output voltage waveform with the second reference value in a conduction period of the phase controller 2. Further, the distortion detection circuit 43 outputs an abnormality of the load 12 when each distortion component is equal to or more than the first or second reference value. Therefore, burn-out of the load 12 is detected regardless of the supply of the bypass current.

According to the load control device 41 of the present embodiment, since the distortion detection circuit 43 is operated in a bypass current period when a bypass current is supplied, and the distortion detection circuit 43 is operated in a conduction period of the phase controller 2 when a bypass current stops flowing, there is an effect that an abnormality (burn-out) of the load 12 can be detected regardless of the supply of a bypass current.

In addition, in the present embodiment, if a conduction period (conduction angle) for the thyristors 15 and 16 of the phase control circuit 6 is set in advance, the first and second reference signals in the comparison signal calculation unit 46 may be stored in a storage unit in advance.

In addition, in the first to fifth embodiments, a zero cross point, zero cross timing, or the like is not limited to an exact zero cross and may be a little deviated from the zero cross.

Further, in the load control devices 1, 21, 31 and 51 of the first to third and fifth embodiments, the switch SW may be replaced with the phase control circuit 32. In this case, the control circuit 7 may output a gate signal (for example, a pulse signal) to the thyristors 33 and 34 of the phase control circuit 32 at the zero cross timing of an AC voltage of the AC power supply Vs.

Furthermore, the load control devices 1, 21, 31, 41 and 51 of the present embodiments may be configured by appropriately combining the configurations of the first to fifth embodiments with each other.

Next, sixth to eighth embodiments will be described.

An additional object of these embodiments is to provide a load control device which can rapidly detect disconnection or short-circuit on a secondary side line of an output transformer without using a meter transformer.

The load control device of these embodiments includes saturable devices, loads, a phase controller, and a controller. Here, a firing angle indicates a phase angle at which the phase controller is conducted.

A plurality of saturable devices are connected in series to each other. A plurality of loads are respectively connected to the saturable devices, and are supplied with power via the saturable devices. The phase controller controls a phase of an output voltage of an AC power supply so as to be supplied to each load.

The controller sets an output of the phase controller, and controls the output thereof to a set output value by performing current-feedback control on a firing angle of the phase controller. In addition, if a firing angle of the phase controller is equal to or lower than a preset lower limit value or is equal to or more than a preset upper limit value, an output of the phase controller is stopped or reduced.

According to these embodiments, since the controller uniformly controls, namely, controls and maintains an output of the phase controller to a set output value by controlling a firing angle of the phase controller, the firing angle is controlled so as to gradually decrease if an output side of the phase controller is disconnected, and the disconnection can be detected when the firing angle becomes a preset lower limit value or less. In addition, the firing angle is controlled so as to gradually increase if the output side of the phase controller is short-circuited, and the short-circuit can be detected when the firing angle becomes a preset upper limit value or more.

In addition, according to these embodiments, when a firing angle of the phase controller is equal to or more than a predetermined value, a bypass current stops being supplied so as to suppress overcurrent.

First, the sixth embodiment will be described.

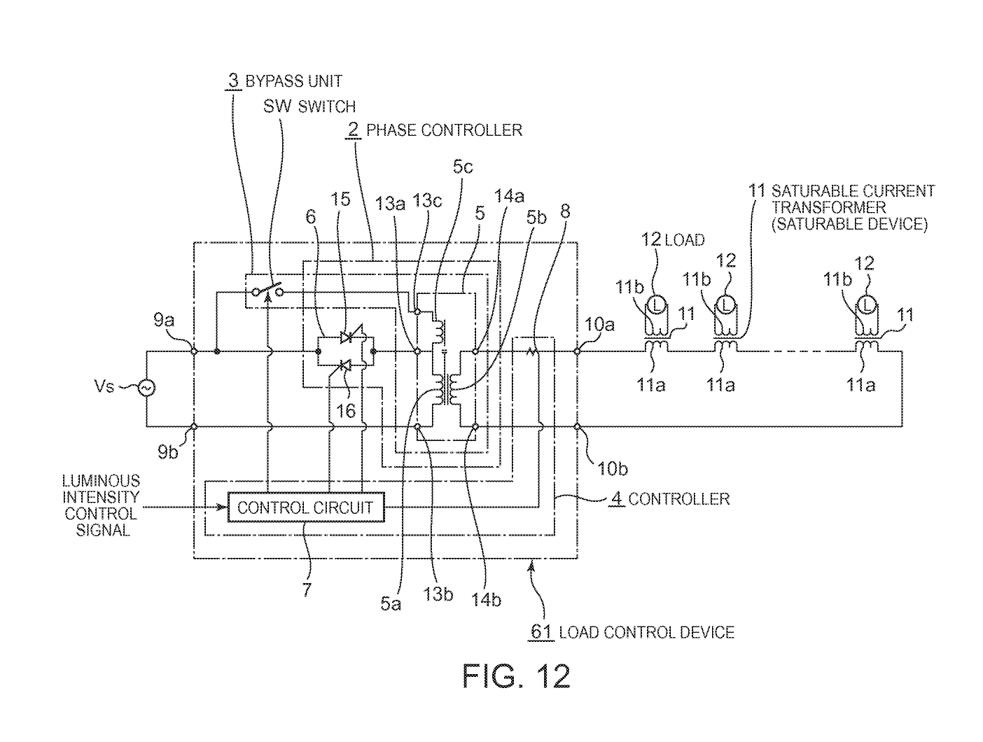

A load control device 61 according to the present embodiment performs constant current control on, for example, lights provided in a taxiway or the like of an airfield, and, as shown in FIG. 12, includes a phase controller 2, a bypass unit 3, and a controller 4. In addition, the phase controller 2 includes a leakage transformer 5 and a phase control circuit 6, and the bypass unit 3 includes a switch SW and the leakage transformer 5. Further, the controller 4 includes a control circuit 7 and a current transformer 8.

Input terminals 9a and 9b of the load control device 61 are connected to an AC power supply Vs, and output terminals 10a and 10b thereof are connected to saturable current transformers 11 which are a plurality of saturable devices connected in series. A load 12, which is a marker lamp using, for example, a light bulb or a light emitting diode as a light source, is connected to each saturable current transformer 11 so as to be supplied with power. A sinusoidal AC voltage (AC current) output from the AC power supply Vs is input to the input terminals 9a and 9b of the load control device 61.

In the leakage transformer 5 of the phase controller 2, both ends of a primary winding 5a which is a primary side are connected to input terminals 13a and 13b, both ends of a secondary winding 5b which is a secondary side are connected to output terminals 14a and 14b, and both ends of a tertiary winding 5c are connected to input terminals 13a and 13c. The input terminal 13b is connected to the input terminal 9b of the load control device 61, the input terminal 13a is connected to the input terminal 9a of the load control device 61 via the phase control circuit 6, and the input terminal 13c is connected to the input terminal 9a of the load control device 61 via the switch SW. The output terminals 14a and 14b are connected to the output terminals 10a and 10b of the load control device 61.

In other words, the input terminals 13a and 13b of the leakage transformer 5 are connected to the AC power supply Vs via the phase control circuit 6, and the input terminals 13c and 13b are connected to the AC power supply Vs via the switch SW. The leakage transformer 5 boosts an AC voltage input to the input terminals 13a (13c) and 13b so as to be output from the output terminals 14a and 14b.

Primary windings 11a of the saturable current transformers 11 are connected in series to the output terminals 10a and 10b. An AC current corresponding to an AC voltage which is input to the input terminals 13a (13c) and 13b of the leakage transformer 5 flows through the primary winding 11a of the saturable current transformer 11.

The phase control circuit 6 includes thyristors 15 and 16 which are connected in parallel to each other in opposite directions, and is connected between the input terminal 9a and the input terminal 13a of the leakage transformer 5. The thyristors 15 and 16 control a phase of an AC voltage from the AC power supply Vs, and conducts the AC voltage from a time point when a gate signal (for example, a pulse signal) from the control circuit 7 is input to gates thereof to a time point when the AC voltage crosses the zero point (until the voltage becomes a self-holding current or less). During the conduction period, a phase-controlled voltage of the AC voltage is input between the input terminals 13a and 13b of the leakage transformer 5.

As above, the phase controller 2 controls a phase of an output voltage (a sinusoidal AC voltage) of the AC power supply Vs so as to be supplied to a plurality of loads 12. Here, in the phase controller 2 (the phase control circuit 6), a firing angle is a phase angle at which the phase controller 2 (the phase control circuit 6) is conducted, and, specifically, indicates a value of an angle (period) from the zero cross (0°) point to the time when the thyristors 15 and 16 are conducted in the half cycle 180° of an AC voltage. In other words, the firing angle corresponds to an elapsed time of a time point when the thyristors 15 and 16 are conducted with respect to the zero cross (0°) point. The firing angle is also referred to as a conduction angle or a conduction phase angle. In addition, a conduction period of the phase controller 2 (the phase control circuit 6) indicates a period after the thyristors 15 and 16 are conducted until the thyristors 15 and 16 are not conducted in the half cycle 180° of an AC voltage.

Further, the phase control circuit 6 is not limited to a configuration using the thyristors 15 and 16, and may be a configuration of phase-controlling an AC voltage of the AC power supply Vs such as a switching unit or a triac using a diode bridge and a transistor. A firing angle in this case is a value of an angle (period) from the zero cross point of an AC voltage to a conduction point.

The switch SW of the bypass unit 3 is connected between the input terminal 9a and the input terminal 13c of the leakage transformer 5. In other words, the switch SW is connected in parallel to the phase control circuit 6 via the tertiary winding 5c of the leakage transformer 5. The bypass unit 3 is formed so as to include the switch SW and the tertiary winding 5c of the leakage transformer 5 connected in series.

During a period when the phase controller 2 is not conducted, a sinusoidal voltage from the AC power supply Vs is input to the input terminals 13a and 13b of the leakage transformer 5 via the tertiary winding 5c. Thus, a reduced bypass current flows through the tertiary winding 5c and the primary winding 5a. The switch SW is controlled so as to be turned on and off by the control circuit 7 of the controller 4, and conducts an AC voltage during a turned-on period. In the present embodiment, the switch SW is normally controlled so as to be turned on by the control circuit 7. The switch SW may use a relay or a semiconductor switch. In this way, the bypass unit 3 can supply a reduced bypass current so as to bypass the phase controller 2 from a zero cross point of each half cycle of an AC voltage from the AC power supply Vs.

Each of the loads 12 is connected between both ends of a secondary winding 11b which is a secondary side of the saturable current transformer 11. The load 12 is a marker lamp which includes, for example, a light bulb or a light emitting diode and a turning-on control device of the light emitting diode. When a current output from the leakage transformer 5 flows through the primary winding 11a of the saturable current transformer 11, a current flows through the secondary winding 11b so as to turn on the load 12. The load 12 varies a luminous intensity level according to an output current from the leakage transformer 5. In this way, a plurality of loads 12 are supplied with power via a plurality of saturable current transformers 11 connected in series to each other so as to be turned on.

In the controller 4, the current transformer 8 is provided so as to detect a current which flows through the secondary winding 5b which is a secondary side of the leakage transformer 5. In other words, an output current of the leakage transformer 5 which flows through the saturable current transformer 11 is detected. A detected value of the output current of the leakage transformer 5 is input to the control circuit 7 at all times.

The control circuit 7 has a microcomputer, outputs a gate signal (for example, a pulse signal) to the thyristors 15 and 16 of the phase control circuit 6 so as to control an input period at the half cycle of an AC voltage which is input to the input terminals 13a and 13b of the leakage transformer 5, and performs control such that an output current of the leakage transformer 5 becomes a constant current corresponding to a luminous intensity level of the load 12.

The control circuit 7 receives a signal for setting an output of the phase controller 2, that is, a luminous intensity control signal for setting a luminous intensity level of the load 12, from an external device. In addition, the control circuit 7 calculates an output of the phase controller 2, that is, an output current (output voltage) of the leakage transformer 5 so as to be set according to a corresponding luminous intensity control signal. A luminous intensity control signal in an airfield is typically set to five levels. In other words, a luminous intensity of the load 12 is varied to 100%, 25%, 5%, 1%, and 0.2%. However, the present embodiment is not limited thereto. For example, a signal for continuously varying a luminous intensity may be used.

In addition, the control circuit 7 receives a detected value of an output current of the leakage transformer 5 from the current transformer 8. In other words, an output value of the leakage transformer 5 is input thereto. Further, although not shown, the control circuit 7 is connected to the input terminals 9a and 9b and receives an AC current of the AC power supply Vs. The control circuit 7 detects zero cross timing of an AC voltage of the AC power supply Vs.

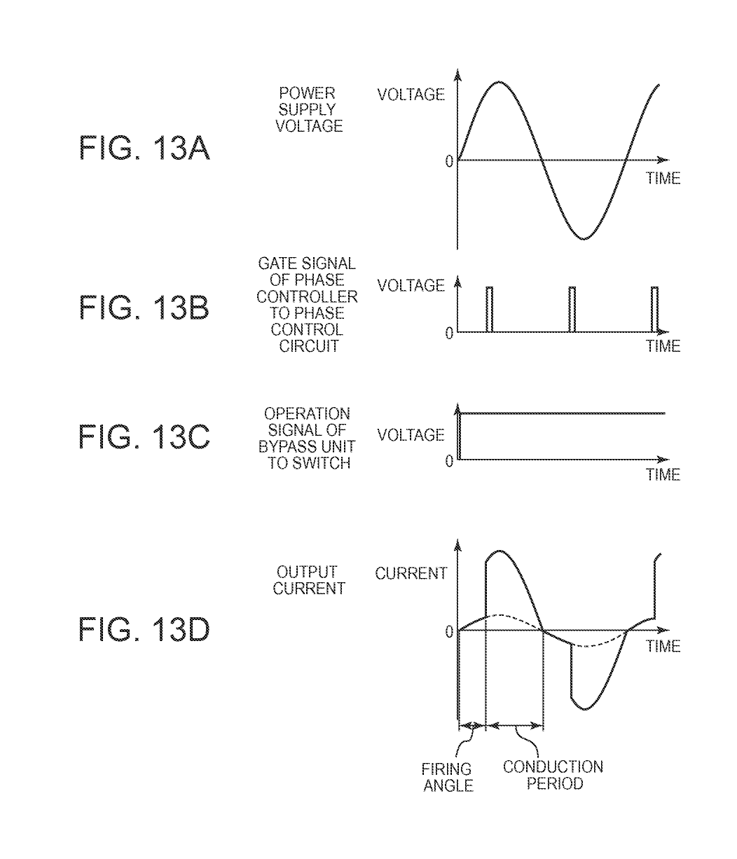

In addition, when the luminous intensity control signal is a control signal for turning on the load 12 in a certain luminous intensity level, the control circuit 7 calculates and determines a firing angle of an AC voltage corresponding to the luminous intensity control signal, and outputs a gate signal as shown in FIG. 13B to the gates of the thyristors 15 and 16 of the phase control circuit 6 such that the AC voltage is input to the input terminals 13a and 13b of the leakage transformer 5 at the firing angle.

Therefore, an AC voltage of which a conduction period is controlled, that is, a phase-controlled voltage is input to the input terminals 13a and 13b of the leakage transformer 5. As a result, a voltage corresponding to a sum of a voltage by the bypass unit 3 and the phase-controlled voltage is input to the leakage transformer 5. The leakage transformer 5 boosts this voltage so as to be output from the output terminals 14a and 14b. A current as shown in FIG. 13D flows through the load 12 according to this output voltage so as to turn on the load 12.

In addition, as shown in FIG. 13C, if the luminous intensity control signal is a control signal for turning on the load 12 in a certain luminous intensity level, the control circuit 7 turns on the switch SW. A low AC voltage is input between the input terminals 13a and 13b of the leakage transformer 5 via the tertiary winding 5c, and thus a reduced bypass current flows therethrough. Accordingly, a low AC current flows between the output terminals 14a and 14b via the saturable current transformers 11.

Since a value of the AC voltage input to the input terminals 13a and 13b of the leakage transformer 5 is large after the phase control circuit 6 is controlled so as to be conducted, an output current from the leakage transformer 5 is a low current until the phase control circuit 6 is controlled so as to be conducted, as shown in FIG. 13D, and is a current (large current) of which a phase is controlled by the phase control circuit 6 from a time point when the phase control circuit 6 is controlled so as to be conducted to a zero cross point of an AC current.

Further, the control circuit 7 controls a firing angle of the thyristors 15 and 16 of the phase control circuit 6 such that a current detected by the current transformer 8 becomes a predetermined current corresponding to a luminous intensity control signal. In other words, the controller 4 sets an output of the phase controller 2 and uniformly controls the output thereof to a set output value according to an input luminous intensity control signal through current-feedback control. Accordingly, the load 12 is turned on in a luminous intensity level corresponding to the luminous intensity control signal.

In addition, the control circuit 7 turns off the switch SW when a firing angle of the phase controller 2 exceeds a predetermined value. In other words, the controller 4 controls the bypass unit 3 so as to start the supply of a bypass current using the bypass unit 3 before the phase controller 2 controls a phase if a firing angle of the phase controller 2 is equal to or lower than a predetermined value, and to stop the supply of the bypass current using the bypass unit 3 if the firing angle of the phase controller 2 exceeds the predetermined value.

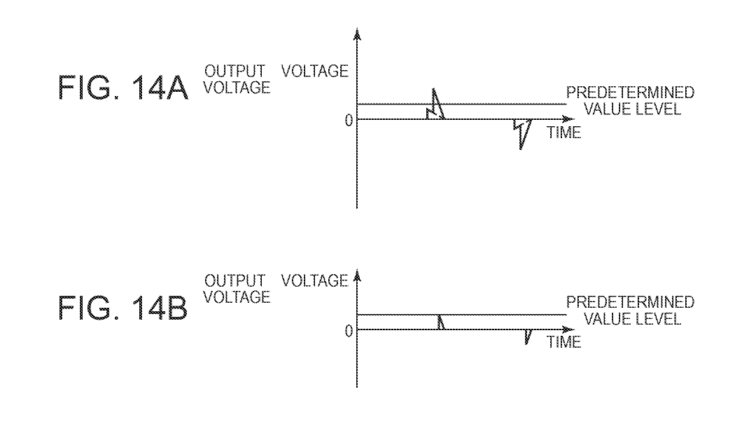

The predetermined value in the present embodiment is equal to or lower than the upper limit value, and is set to a firing angle around the upper limit value in advance. Here, the around the upper limit value may be in a range between a firing angle of the upper limit value and a firing angle which is 30° smaller than the upper limit value. The control circuit 7 allows a bypass current to flow immediately before the phase control circuit 6 is conducted, for example, as shown in FIG. 14A, if a firing angle of the phase controller 2 is equal to or lower than a predetermined value and around the predetermined value, and turns off the switch SW so as to stop the supply of the bypass current, as shown in FIG. 14B, if a firing angle exceeds the predetermined value. The switch SW is turned off, and thus an output voltage (output current) of the leakage transformer 5 is varied only by controlling a firing angle of the phase control circuit 6.

Further, if a luminous intensity control signal is a control signal of a luminous intensity level 0% for not turning on the load 12, the control circuit 7 stops phase control of the phase controller 2 so as to stop the supply of the bypass current using the bypass unit 3. In other words, a gate signal is not output to the thyristors 15 and 16 of the phase control circuit 6, and an Off signal is output to the switch SW.

In addition, if a firing angle of the phase controller 2 is equal to or lower than the lower limit value (for example, 10°) or equal to or more than the upper limit value (for example, 170°), the control circuit 7 stops phase control of the phase controller 2 so as to stop outputting of the phase controller 2 and to stop the supply of the bypass current using the bypass unit 3. In other words, the control circuit 7 stops outputting a gate signal to the thyristors 15 and 16 of the phase control circuit 6 and outputs an Off signal to the switch SW of the bypass unit 3. The lower limit value and the upper limit value are set in advance, and are stored in a storage unit (not shown) or a program for operating the control circuit 7.

If the luminous intensity control signal is a control signal for turning on the load 12 in a luminous intensity level 100%, a firing angle of the thyristors 15 and 16 of the phase control circuit 6 is set to, for example, 70° in the present embodiment. The control circuit 7 calculates and sets an output of the phase controller 2 for the firing angle 70°, that is, a value of an output current (output value) which flows between the output terminals 14a and 14b of the leakage transformer 5, and outputs a gate signal to the thyristors 15 and 16 at a time point of the firing angle 70°. Accordingly, an output current corresponding to the luminous intensity level 100% flows through the primary winding 11a of the saturable current transformer 11 so as to turn on the load 12 in a level of 100%.

In addition, the control circuit 7 calculates a firing angle such that an output current detected by the current transformer 8 becomes a predetermined output current corresponding to the luminous intensity level 100%, and controls conduction of the thyristors 15 and 16 at the corresponding firing angle. In other words, depending on fluctuation in a voltage of the AC power supply Vs, a firing angle is reduced if an output current between the output terminals 14a and 14b of the leakage transformer 5 becomes smaller than a predetermined output current, and, conversely, a firing angle is increased if an output current between the output terminals 14a and 14b of the leakage transformer 5 becomes larger than the predetermined output current, thereby controlling a conduction period of the thyristors 15 and 16 of the phase control circuit 6.

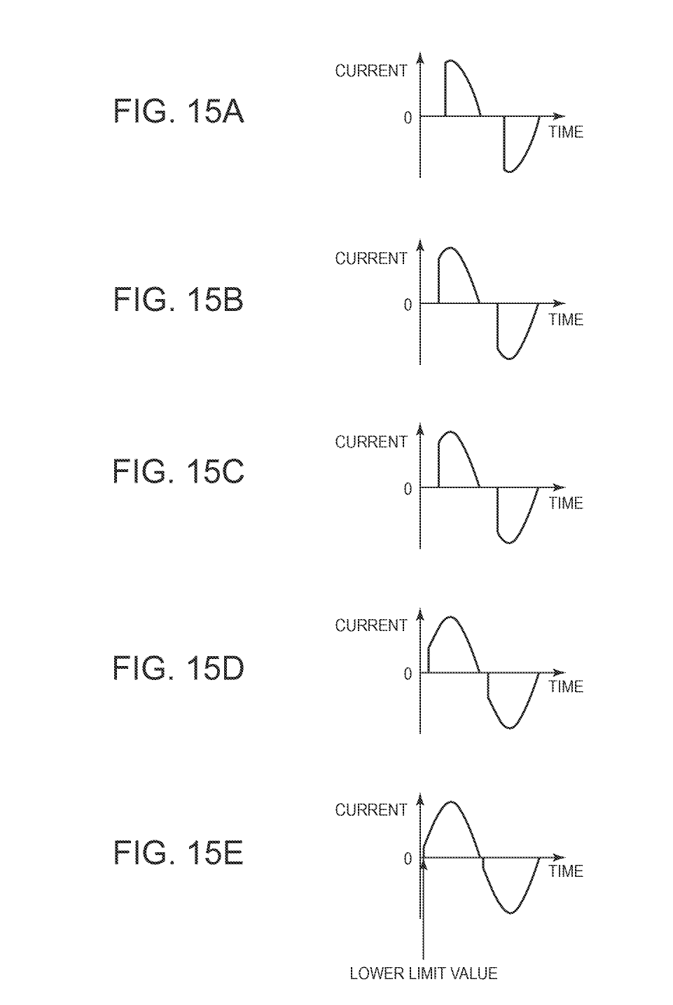

Here, when the line between the output terminals 14a and 14b of the leakage transformer 5 is disconnected, an output current value detected by the current transformer 8 becomes a zero level. The control circuit 7 gradually reduces a firing angle such that a predetermined output current flows between the output terminals 14a and 14b of the leakage transformer 5 as shown in FIGS. 15A to 15E, and outputs a gate signal to the thyristors 15 and 16 of the phase control circuit 6. Since a current does not flow between the output terminals 14a and 14b of the leakage transformer 5, a firing angle is equal to or lower than the lower limit value (for example, 10°). At this time, the control circuit 7 determines that the line between the output terminals 14a and 14b of the leakage transformer 5 is disconnected, stops outputting a gate signal to the thyristors 15 and 16 of the phase control circuit 6, and outputs an Off signal to the switch SW of the bypass unit 3.

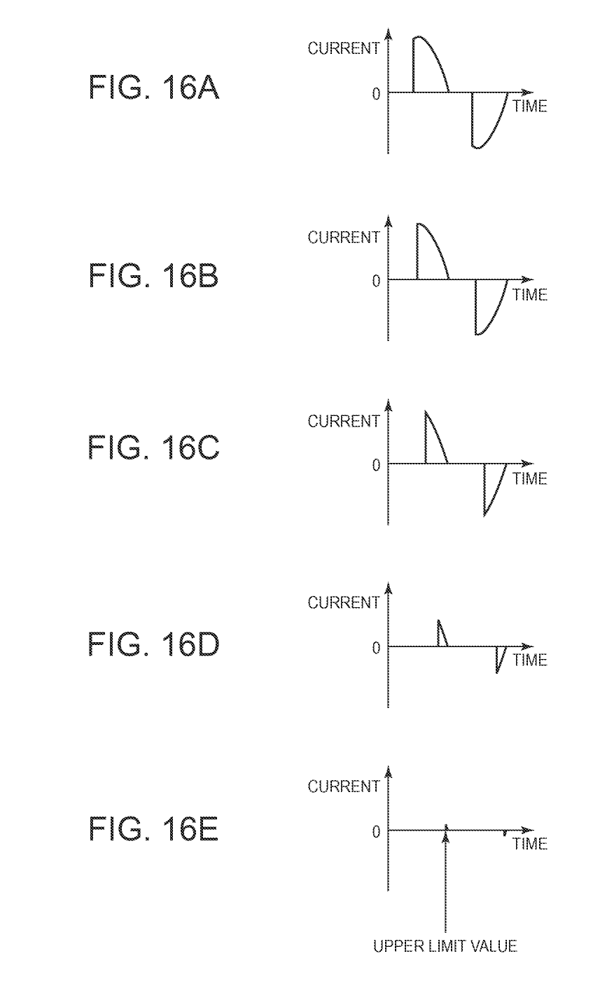

In addition, if the output terminals 14a and 14b of the leakage transformer 5 are short-circuited, an output current value detected by the current transformer 8 is large. The control circuit 7 gradually increases a firing angle such that a predetermined output current flows between the output terminals 14a and 14b of the leakage transformer 5 as shown in FIGS. 16A to 16E, and outputs a gate signal to the thyristors 15 and 16 of the phase control circuit 6. When the predetermined output current flows between the output terminals 14a and 14b of the leakage transformer 5, a firing angle is equal to or more than the upper limit value (for example, 170°). At this time, the control circuit 7 determines that the output terminals 14a and 14b of the leakage transformer 5 are short-circuited, stops outputting a gate signal to the thyristors 15 and 16 of the phase control circuit 6, and outputs an Off signal to the switch SW of the bypass unit 3.

The lower limit value is set between a firing angle in the luminous intensity level 100% and the zero cross (0°), and may be set to a firing angle of 10° to 30° in consideration of voltage fluctuation of the AC power supply Vs, various characteristic disparities, or the like. In addition, the upper limit value is set between a firing angle of the predetermined value and the zero cross (180°) since the load 12 is turned on in a low level luminous intensity in the present embodiment, and may be set to a firing angle of 160° to 175° in consideration of voltage fluctuation of the AC power supply Vs, or the like.

Next, an operation of the sixth embodiment will be described.

When a luminous intensity control signal is a control signal for turning on the load 12 in a certain luminous intensity level, and a firing angle of the phase controller 2 is equal to or lower than a predetermined value, the switch SW of the bypass unit 3 is turned on by the control circuit 7, and thus a low output current flows between the output terminals 14a and 14b of the leakage transformer 5 at all times. In other words, a low current flows through the saturable current transformers 11 even in a period when the thyristors 15 and 16 of the phase control circuit 6 are not conducted. Therefore, when the load 12 is burnt out, a pulsive high voltage does not occur between both ends of the secondary winding 11b of the saturable current transformer 11 at a time point when the thyristors 15 and 16 of the phase control circuit 6 are conducted.

In addition, the control circuit 7 sets an output of the phase controller 2 corresponding to a luminous intensity control signal from an external device, that is, an output current value of the leakage transformer 5, and performs current-feedback control on a firing angle of the thyristors 15 and 16 of the phase control circuit 6 such that the output current value uniformly has a set output value. Further, if the firing angle exceeds the predetermined value, the switch SW of the bypass unit 3 is controlled so as to be turned off, and thus an output current of the leakage transformer 5 is controlled only by controlling a conduction state of the thyristors 15 and 16 of the phase control circuit 6. Therefore, the load 12 can be turned on in a low luminous intensity level.

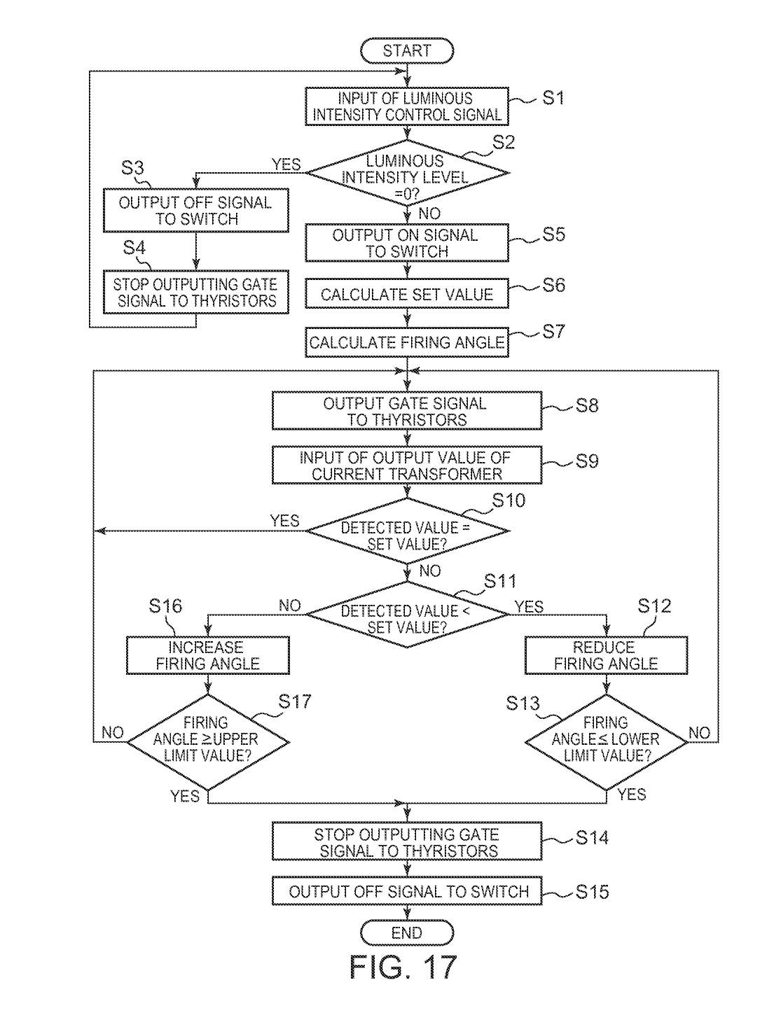

Next, a description will be made of control of the control circuit 7 for disconnection and short-circuit between the output terminals 14a and 14b of the leakage transformer 5 with reference to FIG. 17.

When a luminous intensity control signal is input from an external device (Act 1), the control circuit 7 determines whether or not the luminous intensity control signal is a control signal for turning on the load 12 in a certain luminous intensity level (Act 2). In other words, it is determined whether or not the luminous intensity control signal has the luminous intensity level 0% for not turning on the load 12.

If the luminous intensity control signal has the luminous intensity level 0%, an Off signal is output to the switch SW of the bypass unit 3 (Act 3), and a gate signal is not output to the thyristors 15 and 16 of the phase control circuit 6 (Act 4). Accordingly, an AC voltage of the AC power supply Vs is not input between the input terminals 13a and 13b of the leakage transformer 5, and thus a voltage is not generated between the output terminals 14a and 14b of the leakage transformer 5.

In addition, if the luminous intensity control signal is a control signal for turning on the load 12 in a certain luminous intensity level, an On signal is output to the switch SW of the bypass unit 3 (Act 5), and an output of the phase controller 2 corresponding to the luminous intensity control signal is calculated so as to be set as a set value (output value) (Act 6). In other words, an output current value of the leakage transformer 5 is set as an output value of the phase controller 2.

In addition, a firing angle of the thyristors 15 and 16 of the phase control circuit 6 for obtaining the set value (the output current value) is calculated and determined (Act 7), and a gate signal is output to the thyristors 15 and 16 at a time point of the firing angle (Act 8). The thyristors 15 and 16 are conducted, and a phase-controlled voltage obtained by phase-controlling an AC voltage of the AC power supply Vs at the firing angle is input between the input terminals 13a and 13b of the leakage transformer 5. Therefore, an output current corresponding to the luminous intensity control signal flows between the output terminals 14a and 14b of the leakage transformer 5.

Further, the outputting of the On signal of the switch SW in Act 5 may be performed immediately before a gate signal is output to the thyristors 15 and 16, or at the zero cross point of the AC voltage, that is, may be performed from the zero-cross point to the time point of outputting the gate signal.

An output current of the leakage transformer 5 is detected by the current transformer 8. The control circuit 7 receives the detected value (Act 9) and determines whether or not the detected value matches the set value (the output value) which is set in Act 6 (Act 10). In other words, it is determined whether or not the output current of the leakage transformer 5 is an output current corresponding to the luminous intensity control signal.

If the detected value of the current transformer 8 matches the set value, a gate signal is output to the thyristors 15 and 16 at the time point of the firing angle without changing the firing angle (Act 8). On the other hand, if the detected value of the current transformer 8 does not match the set value, the magnitudes of the detected value and the set value are compared with each other (Act 11).

The control circuit 7 reduces the firing angle if the detected value is smaller than the set value (Act 12). In other words, the conduction period of the thyristors 15 and 16 of the phase control circuit 6 is lengthened so as to increase an output current of the leakage transformer 5. Here, the control circuit 7 may reduce the firing angle by a certain number, may reduce the firing angle at a certain rate corresponding to the firing angle, may reduce the firing angle by calculating a firing angle corresponding to a difference between the detected value and the set value, or may reduce the firing angle using an appropriate unit which reduces a firing angle by reducing the difference at a certain rate or the like. In the present embodiment, as shown in FIGS. 15A to 15E, a firing angle corresponding to the difference between the detected value and the set value is reduced over four to ten cycles of an AC voltage.

The reduced new firing angle is compared with the lower limit value (for example, 10°) (Act 13). In addition, if the firing angle exceeds the lower limit value, a gate signal is output to the thyristors 15 and 16 at a time point of the new firing angle (Act 8). Subsequently, the control in the above-described Acts 9 to 11 is performed.

In addition, if the firing angle is equal to or lower than the lower limit value in Act 13, the control circuit 7 determines that the output terminals 14a and 14b of the leakage transformer 5 are disconnected from each other, stops outputting a gate signal to the thyristors 15 and 16 of the phase control circuit 6 (Act 14), and outputs an Off signal to the switch SW of the bypass unit 3 (Act 15). In other words, when the disconnection between the output terminals 14a and 14b of the leakage transformer 5 is detected, the control circuit 7 stops phase control of the phase control circuit 6 of the phase controller 2 and stops the supply of the bypass current using the bypass unit 3. Accordingly, an AC voltage of the AC power supply Vs is not input between the input terminals 13a and 13b of the leakage transformer 5, and thus a voltage (output) is not generated between the output terminals 14a and 14b of the leakage transformer 5, thereby securing safety on the output side of the leakage transformer 5.

Further, if the detected value is greater than the set value in Act 11, the control circuit 7 increases the firing angle (Act 16). In other words, the conduction period of the thyristors 15 and 16 of the phase control circuit 6 is shortened so as to decrease an output current of the leakage transformer 5. Here, the control circuit 7 may increase the firing angle by a certain number, may increase the firing angle at a certain rate corresponding to the firing angle, may increase the firing angle by calculating a difference between the detected value and the set value, or may increase the firing angle using an appropriate unit which increases a firing angle by increasing the difference at a certain rate or the like. In the present embodiment, as shown in FIGS. 16A to 16E, a firing angle corresponding to the difference between the detected value and the set value is increased over four to ten cycles of an AC voltage.

The increased new firing angle is compared with the upper limit value (for example, 170°) (Act 17). In addition, if the firing angle is smaller than the upper limit value, a gate signal is output to the thyristors 15 and 16 at a time point of the new firing angle (Act 8). Subsequently, the control in the above-described Acts 9 to 11 is performed.

In addition, if the firing angle is equal to or more than the upper limit value in Act 17, the control circuit 7 determines that the output terminals 14a and 14b of the leakage transformer 5 are short-circuited to each other, stops outputting a gate signal to the thyristors 15 and 16 of the phase control circuit 6 (Act 14), and outputs an Off signal to the switch SW of the bypass unit 3 (Act 15). In other words, when the short-circuit between the output terminals 14a and 14b of the leakage transformer 5 is detected, the control circuit 7 stops phase control of the phase control circuit 6 of the phase controller 2 and stops the supply of the bypass current using the bypass unit 3. Accordingly, a voltage (output) is not generated between the output terminals 14a and 14b of the leakage transformer 5, thereby securing safety on the output side of the leakage transformer 5.

As above, a firing angle of the thyristors 15 and 16 of the phase control circuit 6 is compared with the upper limit value and the lower limit value which are set in advance, and thus disconnection and short-circuit between the output terminals 14a and 14b of the leakage transformer 5 are detected. In addition, when the disconnection and short-circuit are detected, phase control of the phase control circuit 6 is stopped, and the supply of the bypass current using the bypass unit 3 is stopped, thereby securing safety on the output side of the leakage transformer 5.

According to the load control device 61 of the present embodiment, since the control circuit 7 detects disconnection between outputs of the leakage transformer 5 when a firing angle of the thyristors 15 and 16 of the phase control circuit 6 is equal to or lower than the preset lower limit value, and detects short-circuit between the outputs of the leakage transformer 5 when the firing angle is equal to or more than the preset upper limit value, the disconnection and short-circuit can be rapidly detected. Therefore, there is an effect that safety between the outputs of the leakage transformer 5 can be rapidly secured. In addition, since a meter transformer is not required to be provided on the output side of the leakage transformer 5, and thus an input unit or a processing unit of a value detected by the meter transformer is not required to be provided in the control circuit 7, there is an effect that the load control device 61 can be configured at low cost.

The present embodiment has the following features as is clear from the above description.

First, output waveforms (output waveforms of the load control device 61) of the bypass unit 3 and the phase controller 2 (the phase control circuit 6) include

a) a waveform (type A) in which a phase-controlled current is superimposed on a bypass current which flows from the zero cross as shown in FIG. 13D, and

b) a waveform (type B) in which a bypass current is supplied immediately before the phase controller 2 (the phase control circuit 6) is conducted as shown in FIG. 14A.

In the present embodiment, both of a) and b) may be used.

Second, if a firing angle exceeds a predetermined value, the phase controller 2 (the phase control circuit 6) is conducted, whereas the switch SW is turned off so as to stop the supply of a bypass current and to suppress overcurrent.

For example,

c) in a case where a firing angle (conduction phase)≦ a predetermined value (for example, 140°), the phase controller is conducted (the phase control circuit is conducted), and the bypass unit 3 is conducted (the switch SW is turned on), and

d) in a case where a predetermined value (for example, 140°)< a firing angle (conduction phase), the phase controller is conducted (the phase control circuit is conducted), and the bypass unit 3 is not conducted (the switch SW is turned off).

In addition, the half cycle of an AC voltage (AC current) is 180°.

Third, if a firing angle is equal to or lower than a preset lower limit value or equal to or more than a preset upper limit value, an output of the phase controller 2 (the phase control circuit 6) is stopped or reduced, and thus disconnection or short-circuit on the output side of the phase controller 2 (disconnection or short-circuit between the output terminals 14a and 14b of the leakage transformer 5) can be detected.

For example,

e) if a firing angle is reduced to the lower limit value or less (the firing angle ≦ the lower limit value (for example, 10°)) (determination of disconnection), conduction of the phase controller 2 (the phase control circuit 6) is changed from an On state to an Off state, and conduction of the bypass unit 3 (the switch SW) is changed from an On state to an Off state, and

f) if a firing angle is increased to the upper limit value or more (the firing angle ≧ the upper limit value (for example, 170°)) (determination of short-circuit), conduction of the phase controller 2 (the phase control circuit 6) is changed from an On state to an Off state, and conduction of the bypass unit 3 (the switch SW) is in an Off state.

Next, the seventh embodiment will be described.

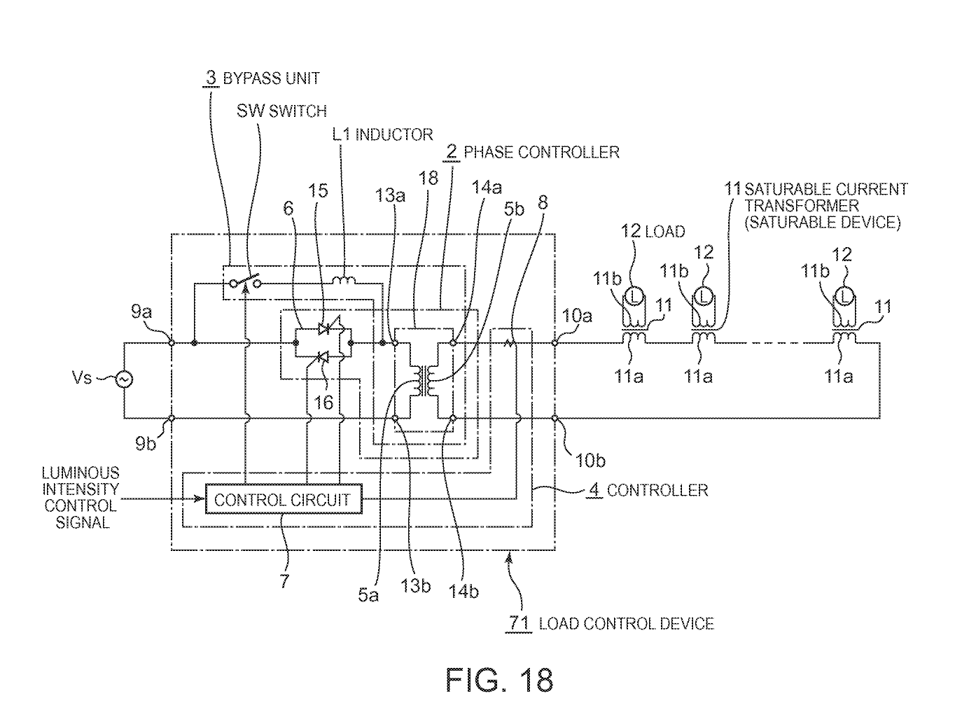

A load control device 71 of the present embodiment is configured as shown in FIG. 18.

The load control device 71 has a configuration in which the leakage transformer 5 of the load control device 61 shown in FIG. 12 is replaced with a transformer 18 and an inductor L1, and has the same operations and effects as the load control device 61.

In addition, in the present embodiment, the transformer 18 may be omitted, and the phase controller 2 may be directly connected to the saturable current transformers 11 which are connected in series. In this case, a current limiting impedance portion may be connected to the line path in preparation for short-circuit of the load 12 side.

Next, the eighth embodiment will be described.

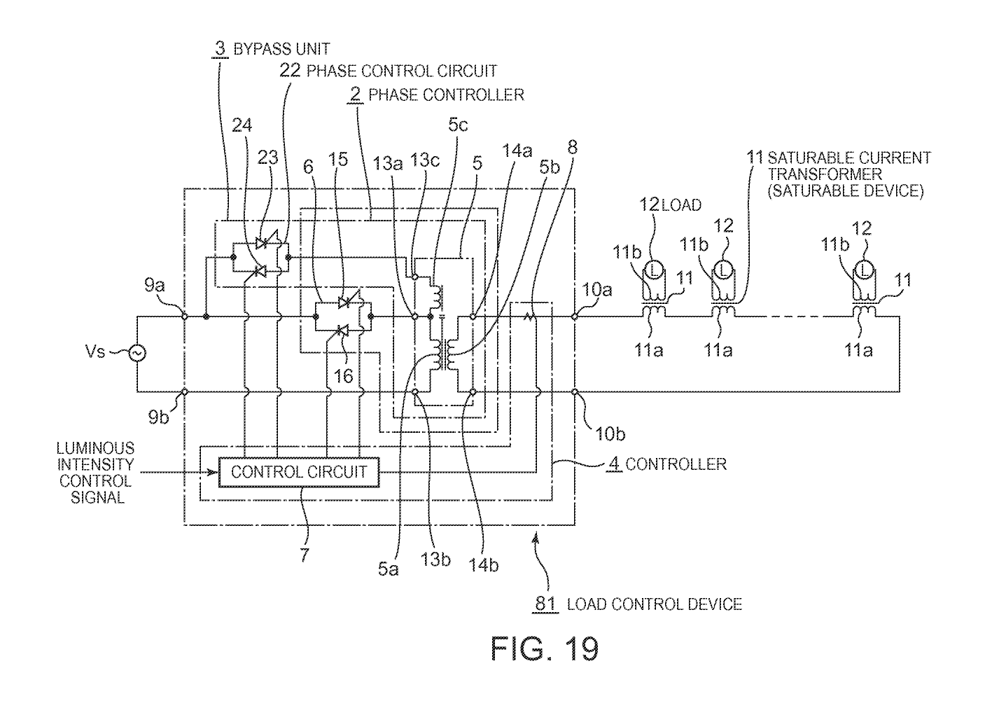

A load control device 81 of the present embodiment is configured as shown in FIG. 19. In addition, in FIG. 19, the same part as in FIG. 12 is given the same reference numeral, and description thereof will be omitted.

The load control device 81 has a configuration in which the switch SW of the bypass unit 3 is replaced with a phase control circuit 22 in the load control device 61 shown in FIG. 12. The phase control circuit 22 includes thyristors 23 and 24 which are connected in parallel to each other in opposite directions, and is connected between the input terminal 9a of the load control device 81 and the input terminal 13c of the leakage transformer 5. The thyristors 23 and 24 alternately conduct an AC voltage from the AC power supply Vs, and conduct the AC voltage from a time point when a gate signal (pulse signal) is input to gates thereof from the control circuit 7. Through the conduction, the AC voltage is input between the input terminals 13a and 13b of the leakage transformer 5.

Further, as shown in FIG. 14A, the control circuit 7 outputs a gate signal to the thyristors 23 and 24 of the phase control circuit 22 of the bypass unit 3 immediately before a gate signal is output to the thyristors 15 and 16 of the phase control circuit 6 of the phase controller 2. In other words, the controller 4 starts the supply of a bypass current using the bypass unit 3 before the phase controller 2 performs phase control if a firing angle of the phase controller 2 is equal to or lower than a predetermined value, and stops the supply of the bypass current using the bypass unit 3 if the firing angle of the phase controller 2 exceeds the predetermined value.

In addition, if a firing angle of the phase controller 2 is equal to or lower than a predetermined value, a bypass current may be allowed to flow from a time point of the zero cross of an AC voltage.

Further, the controller 4 stops the supply of the bypass current using the bypass unit 3 when a firing angle of the phase controller 2 is equal to or lower than a preset lower limit value or equal to or more than a preset upper limit value and thus phase control of the phase controller 2 is stopped. In other words, a gate signal stops being output to the thyristors 23 and 24 of the phase control circuit 22.

According to the load control device 81 of the present embodiment, if disconnection or short-circuit occurs in the outputs of the phase controller 2, and a firing angle of the phase controller 2 is equal to or lower than a lower limit value or equal to or more than an upper limit value, an output of the phase controller 2 is stopped, and the supply of the bypass current using the bypass unit 3 is stopped. Therefore, there is an effect that safety on the output side of the phase controller 2 can be rapidly secured.

In addition, in the sixth to eighth embodiments, when disconnection or short-circuit occurs in the outputs of the phase controller 2, an output of the phase controller 2 may not be stopped, and outputting of the phase controller 2 may be reduced to an extent in which safety on the output side of the phase controller 2 can be secured.

Further, in the sixth to eighth embodiments, the load control devices 61, 71 and 81 include not only the phase controller 2, the bypass unit 3, and the controller 4, but also the saturable current transformers 11 which are a plurality of saturable devices and a plurality of loads 12.

In addition, a saturable device is not limited to the saturable current transformer 11, and may use a saturable transformer, a saturable reactor, or a device formed by a semiconductor switch which conducts a predetermined voltage.

In addition, in the sixth to eighth embodiments, a zero cross point, zero cross timing, or the like is not limited to an exact zero cross and may be a little deviated from the zero cross.

The above description relates to each embodiment.

The load control devices of the first to eighth embodiments have the following common features.

A load control device includes a phase controller that phase-controls an output voltage of an AC power supply so as to be supplied to a plurality of loads which are supplied with power via a plurality of saturable devices connected in series to each other; a bypass unit that can supply a reduced bypass current so as to bypass the phase controller; and a controller that sets an output of the phase controller and controls the output thereof to a set output value, and stops the supply of the bypass current in a condition in which a conduction phase (firing angle) is equal to or more than a predetermined value.

In addition, the load control devices of the first to fifth embodiments have the following additional features.

A load control device includes a phase controller that phase-controls an output voltage of an AC power supply so as to be supplied to a plurality of loads which are supplied with power via a plurality of saturable devices connected in series to each other; a bypass unit that can supply a reduced bypass current so as to bypass the phase controller from a zero cross point of each half cycle of an AC power supply voltage; and a controller that sets an output of the phase controller and controls the output thereof to a set output value, and stops the supply of the bypass current in a condition in which an output value is equal to or lower than a predetermined value (a conduction phase, that is, a firing angle is equal to or more than the predetermined value).

A load control device includes a phase controller that phase-controls an output voltage of an AC power supply so as to be supplied to a plurality of loads which are supplied with power via a plurality of saturable devices connected in series to each other; a bypass unit that can supply a reduced bypass current so as to bypass the phase controller; and a controller that sets an output of the phase controller and controls the output thereof to a set output value, and starts the supply of the bypass current immediately before the phase controller is conducted in a condition in which at least an output value is equal to or lower than a predetermined value (a conduction phase, that is, a firing angle is equal to or more than the predetermined value).

Further, the load control devices of the sixth to eighth embodiments have the following additional features.

A load control device includes a phase controller that phase-controls an output voltage of an AC power supply so as to be supplied to a plurality of loads which are supplied with power via a plurality of saturable devices connected in series to each other; and a controller that sets an output of the phase controller and controls the output thereof to a set output value by performing current-feedback control on a firing angle of the phase controller, and stops or reduces an output of the phase controller when the firing angle is equal to or lower than a present lower limit value or is equal to or more than a preset upper limit value.

The load control device further includes a bypass unit that can supply a reduced bypass current so as to bypass the phase controller, in which the controller starts the supply of a bypass current using the bypass unit before the phase controller performs phase control when a firing angle of the phase controller is equal to or lower than an upper limit value and is equal to or lower than a predetermined value which is set around the upper limit value, and stops the supply of the bypass current using the bypass unit when an output of the phase controller is stopped or reduced.

While certain embodiments have been described, these embodiments have been presented by way of example only, and are not intended to limit the scope of the inventions. Indeed, the novel embodiments described herein may be embodied in a variety of other forms; furthermore, various omissions substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A load control device comprising:
a phase controller that phase-controls an output voltage of an AC power supply so as to be supplied to a plurality of loads which are supplied with power via a plurality of saturable devices connected in series to each other;
a bypass unit that can supply a reduced bypass current so as to bypass the phase controller; and
a controller that sets an output of the phase controller and controls the output thereof to a set output value, and stops the supply of the bypass current in a condition in which a conduction phase is equal to or more than a predetermined value.

2. The device according to claim 1, wherein the bypass unit can supply a reduced bypass current so as to bypass the phase controller from a zero cross point of each half cycle of an AC power supply voltage.

3. The device according to claim 1, wherein the controller stops the supply of the bypass current when a conduction phase of the phase controller is equal to or lower than a predetermined value.

4. The device according to claim 1, further comprising a voltage detector that detects an output voltage of the phase controller,
wherein the controller stops the supply of the bypass current when a detected signal of the voltage detector is equal to or lower than a predetermined value.

5. The device according to claim 1, wherein the bypass unit includes a switching portion and a current reduction impedance portion which are connected in series, and the switching portion is controlled so as to be turned on and off by the controller.

6. The device according to claim 1, wherein the controller starts the supply of the bypass current immediately before the phase controller is conducted.

7. The device according to claim 1, further comprising a distortion detector that detects waveform distortion caused by an abnormality of the load,
wherein, when the bypass current is supplied, the distortion detector is operated in a bypass current period, and, when the bypass current stops being supplied, the distortion detector is operated in a conduction period of the phase controller.

8. The device according to claim 1, wherein the conduction phase is a firing angle.

9. The device according to claim 1, wherein the controller performs control to the set output value by performing current-feedback control on a firing angle of the phase controller, and stops or reduces an output of the phase controller when the firing angle is equal to or lower than a preset lower limit value or equal to or more than a preset upper limit value.

10. The device according to claim 1, wherein the controller starts the supply of a bypass current using the bypass unit before the phase controller performs phase control when a firing angle of the phase controller is equal to or lower than an upper limit value and is equal to or lower than a predetermined value which is set around the upper limit value, and stops the supply of the bypass current using the bypass unit when an output of the phase controller is stopped or reduced.

11. The device according to claim 1, when an output waveform is either a waveform in which a phase-controlled current is superimposed on a bypass current which flows from a zero cross or a waveform in which the bypass current flows immediately before the phase controller is conducted, and a firing angle exceeds a predetermined value, the phase controller is conducted and the bypass current stops being supplied, and, when the firing angle is equal to or lower than a preset lower limit value or is equal to or more than a preset upper limit value, an output of the phase controller is stopped or reduced.

12. A lighting apparatus comprising:
a plurality of saturable devices that are connected in series to each other;
a plurality of loads that are supplied with power via the respective saturable devices;
a phase controller that phase-controls an output voltage of an AC power supply so as to be supplied to each load; and
a controller,
wherein the controller sets an output of the phase controller and controls the output thereof to a set output value, and stops the supply of the bypass current in a condition in which a conduction phase is equal to or more than a predetermined value.

13. The apparatus according to claim 12, further comprising a voltage detector that detects an output voltage of the phase controller,
wherein the controller stops the supply of the bypass current when a detected signal of the voltage detector is equal to or lower than a predetermined value.

14. The apparatus according to claim 12, wherein the bypass unit includes a switching portion and a current reduction impedance portion which are connected in series, and the switching portion is controlled so as to be turned on and off by the controller.

15. The apparatus according to claim 12, further comprising a distortion detector that detects waveform distortion caused by an abnormality of the load,
wherein, when the bypass current is supplied, the distortion detector is operated in a bypass current period, and, when the bypass current stops flowing, the distortion detector is operated in a conduction period of the phase controller.
